(19) United States
(12) Patent Application Publication
(10) Pub. No.: US 2025/0294503 A1
(43) Pub. Date: Sep. 18, 2025

(54) TIMING ADVANCE ASSISTED RANGING

(71) Applicant: Telefonaktiebolaget LM Ericsson (PUBL), Stockholm (SE)

(72) Inventors: Peter HAMMARBERG, Mölndal (SE); Satyam DWIVEDI, Solna (SE); Ritesh SHREEVASTAV, Upplands Väsby (SE); Siva MURUGANATHAN, Stittsville (CA); Zhilan XIONG, Solna (SE)

(21) Appl. No.: 18/861,372

(22) PCT Filed: Apr. 28, 2023
(86) PCT No.: PCT/EP2023/061402

§ 371 Date: Oct. 29, 2024

Related U.S. Application Data
(60) Provisional application No. 63/363,843, filed on Apr. 29, 2022.

(51) Int. Cl. H04W 64/00; H04L 5/00; H04W 56/00

(52) U.S. Cl. CPC H04W 64/00; H04L 5/0051; H04W 56/0045

(57) ABSTRACT

According to some embodiments, a method (1100) performed by a first wireless device (110) comprises determining (1112) to perform a ranging procedure with respect to a second wireless device (110); transmitting (1118) a reference signal using uplink timing advance, TA, information; and receiving (1120) a ranging report from a location function (110, 160). The ranging report is based at least upon the TA information used for transmitting the reference signal and a measurement of the transmitted reference signal by the second wireless device (110).

### TECHNICAL FIELD

Embodiments of the present disclosure are directed to wireless communications and, more particularly to timing advanced (TA) assisted ranging.

### BACKGROUND

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other objectives, features, and advantages of the enclosed embodiments will be apparent from the following description.

Third Generation Partnership Project (3GPP) standardization activity includes sidelink (SL) ranging and positioning (as outlined in the study item description RP-213561). Previous standardization work for sidelink in 3GPP focused on the communication aspects. From a positioning perspective, in previous releases, the network has been catering to the need of positioning for the cellular system. Using sidelink measurements in device positioning is therefore a new paradigm for positioning using 3GPP technology.

3GPP new radio (NR) currently supports the following radio access technology (RAT) dependent positioning methods:

DL-TDOA: The downlink (DL) time difference of arrival (TDOA) positioning method uses the downlink reference signal time difference (RSTD) (and optionally downlink position reference signal (PRS) reference signal receive power (RSRP)) of downlink signals received from multiple transmission points (TPs), at the user equipment (UE). The UE measures the downlink RSTD (and optionally DL PRS RSRP) of the received signals using assistance data received from a positioning server, and the resulting measurements are used along with other configuration information to locate the UE in relation to neighboring TPs.

Multi-RTT: The multiple round trip time (Multi-RTT) positioning method uses the UE Rx-Tx measurements and downlink PRS RSRP of downlink signals received from multiple TRPs, measured by the UE and the measured gNB Rx-Tx measurements and uplink (UL) sounding reference signal (SRS) RSRP at multiple TRPs of uplink signals transmitted from UE.

UL-TDOA: The UL TDOA positioning method makes use of the UL TDOA (and optionally UL SRS-RSRP) at multiple reception points (RPs) of uplink signals transmitted from a UE. The RPs measure the UL TDOA (and optionally UL SRS-RSRP) of the received signals using assistance data received from a positioning server, and the resulting measurements are used along with other configuration information to estimate the location of the UE.

DL-AoD: The DL angle of departure (AoD) positioning method uses the measured DL PRS RSRP of downlink signals received from multiple TPs, at the UE. The UE measures the DL PRS RSRP of the received signals using assistance data received from a positioning server, and the resulting measurements are used along with other configuration information to locate the UE in relation to the neighboring TPs.

UL-AoA: The UL angle of arrival (AoA) positioning method uses the measured azimuth and zenith of arrival at multiple RPs of uplink signals transmitted from the UE. The RPs measure A-AoA and Z-AoA of the received signals using assistance data received from a positioning server, and the resulting measurements are used along with other configuration information to estimate the location of the UE.

NR-ECID: NR Enhanced Cell ID (NR E-CID) positioning refers to techniques that use additional UE measurements and/or NR radio resource and other measurements to improve the UE location estimate.

The positioning modes can be categorized according to the following three areas.
UE-Assisted: The UE performs measurements with or without assistance from the network and sends the measurements to the evolved serving mobile location center (E-SMLC) where the position calculation may take place.
UE-Based: The UE performs measurements and calculates its own position with assistance from the network.
Standalone: The UE performs measurements and calculates its own position without network assistance.

3GPP specified the long term evolution (LTE) D2D (device-to-device) technology, also referred to as ProSe (Proximity Services) in Release 12 and 13 of LTE. Later in Rel. 14 and 15, LTE V2X related enhancements targeting the specific characteristics of vehicular communications were specified. 3GPP started a new work item (WI) in August 2018 within the scope of Rel. 16 to develop a new radio version of V2X communications.

The NR V2X mainly targets advanced V2X services, which can be categorized into four use case groups: vehicles platooning, extended sensors, advanced driving, and remote driving. The advanced V2X services require enhancements of the NR system and a new NR sidelink framework may help meet the stringent requirements in terms of latency and reliability. The NR V2X system also expects to have higher system capacity and better coverage and allow for easy extension to support the future development of further advanced V2X services and other services.

Given the services targeted by NR V2X, it is commonly recognized that groupcast/multicast and unicast transmissions are desired, in which the intended receiver of a message consists of only a subset of the vehicles in proximity to the transmitter (groupcast) or of a single vehicle (unicast). For example, in the platooning service certain messages are only of interest to the members of the platoon, making the members of the platoon a natural groupcast. In another example, the see-through use case most likely involves only a pair of vehicles, for which unicast transmissions naturally fit. Therefore, NR sidelink can support broadcast (as in LTE), groupcast and unicast transmissions. Furthermore, NR sidelink is designed for operation with and without network coverage and with varying degrees of interaction between the UEs (and the network), including support for standalone, network-less operation.

National Security and Public Safety (NSPS) is another important use case that can benefit from the already developed NR sidelink features in Rel. 16. Therefore, 3GPP will likely specify enhancements related to the NSPS use case using NR Rel. 16 sidelink as a baseline.

In some scenarios, NSPS services need to operate with partial or without network coverage, such as indoor firefighting, forest firefighting, earthquake rescue, sea rescue, etc. where the infrastructure is (partially) destroyed or not available. Therefore, coverage extension is a crucial enabler for NSPS, for both NSPS services communicated between UE and the cellular network and that communicated between UEs over sidelink. In Rel. 17 includes a study item on NR sidelink relay (RP-193253) to further explore coverage extension for sidelink-based communication, including both UE to network relay for cellular coverage extension and UE to UE relay for sidelink coverage extension. Now the work has proceeded to normative phase and in the work item (RP-213561) only UE to network relay is considered.

In the discussions and planning for NR Rel. 18, sidelink based ranging and positioning has been agreed for standardization. Ranging refers to deriving both distance and angle information about the wireless link between two devices. Distance ranging is today available in other standards, e.g., IEEE 802.4z, where in general, a signal exchange takes place between two devices facilitating calculation of the round-trip-time (RTT).

3GPP is currently discussing standardization of a Positioning Reference Unit (PRU). The PRU may be a node/device that can transmit an uplink signal, perform positioning measurements and whose location is known. These devices may identify positioning errors, and thus the information may be used to compensate the positioning error of a UE.

The PRU may support, at least, some of the Rel-16 positioning functionalities of a UE. The positioning functionalities may include, but not limited to, providing the positioning measurements (e.g., RSTD, RSRP, Rx-Tx time differences) and transmitting the UL SRS signals for positioning. A location management function (LMF) may request the PRU to provide its own known location coordinate information to the LMF. If the antenna orientation information of the PRU is known, that information may also be requested by the LMF.

Transmission timing adjustments are used to keep uplink transmissions from different UEs synchronized upon arrival at the gNB. A goal of the synchronization procedure is to delay or advance the uplink transmission from individual UEs such that when the transmitted signals from the individual UEs are received at the gNB, all incoming radio signals are time aligned. This is required for orthogonal frequency division multiplexing (OFDM) demodulation and securing orthogonality between subcarriers transmitted from different UEs.

The timing is adjusted as the UE moves to reflect the change in propagation delay. This is achieved by transmission of timing advance (TA) commands from the gNB to the individual UEs over medium access control (MAC) control elements. When in connected mode, the TA commands indicate the adjustment relative to the old timing advance. To obtain the actual value for the TA, accumulation over time is required in general.

The uplink and downlink are transmitted with different timing in general. The detailed procedure for transmission timing adjustments is outlined in 3GPP TS 38.213 v17.0.0. Additional details on architecture are also found in 3GPP TS 38.300 v16.8.0.

In 3GPP TS 38.215 v17.0.0, the gNB Rx-Tx time difference measurement is defined as follows. The gNB Rx-Tx time difference is defined as T_{gNB-RX}−T_{gNB-TX}, Where: T_{gNB-RX} is the positioning node received timing of uplink subframe #i containing SRS associated with UE, defined by the first detected path in time; and T_{gNB-TX} is the positioning node transmit timing of downlink subframe #j that is closest in time to the subframe #i received from the UE.

Multiple SRS resources for positioning may be used to determine the start of one subframe containing SRS.

The reference point for T_{gNB-RX} shall be:
for type 1-C base station TS 38.104: the Rx antenna connector,
for type 1-0 or 2-O base station TS 38.104: the Rx antenna (i.e., the center location of the radiating region of the Rx antenna),
for type 1-H base station TS 38.104: the Rx Transceiver Array Boundary connector.

The reference point for T_{gNB-TX} shall be:
for type 1-C base station TS 38.104: the Tx antenna connector,
for type 1-O or 2-O base station TS 38.104: the Tx antenna (i.e., the center location of the radiating region of the Tx antenna),
for type 1-H base station TS 38.104: the Tx Transceiver Array Boundary connector.

Timing advance (TADV) is defined as the time difference T_{ADV}=T_{gNB-RX}−T_{gNB-TX}, where: T_{gNB-RX} is the transmission and reception point (TRP) received timing of uplink subframe #i containing physical random access channel (PRACH) transmitted from UE, defined by the first detected path in time: T_{gNB-TX} is the TRP transmit timing of downlink subframe #j that is closest in time to the subframe #i received from the UE; and the detected PRACH is used to determine the start of one subframe containing the PRACH.

Sidelink communication can occur in three different scenarios: in-coverage (IC), out-of-coverage (OoC) and partial coverage (PC). An example is illustrated in FIG. 1.

FIG. 1 is a network diagram illustrating communication scenarios for sidelink communication and positioning. UEs that are in coverage of a gNB rely on configuration (through radio resource control (RRC) and/or system information block (SIB)) from the network. UEs that are out of coverage rely on a (pre-) configuration available in the subscriber interface module (SIM) of the device. Pre-configuration is (semi-) static and updates are possible (when the UE is in coverage).

The study item description (SID) for the rel. 18 positioning includes sidelink positioning and ranging. This includes both absolute positioning, relative positioning and ranging for different scenarios. In this context, ranging refers to determining the relative distance, and in some scenarios also angle, from one device to another.

More explicitly, the SID covers the following scope for sidelink positioning. SID will study solutions for sidelink positioning considering the following scenarios/requirements:
Coverage scenarios to cover: in-coverage, partial-coverage and out-of-coverage
Requirements: Based on requirements identified in TR38.845 and TS22.261 and TS22.104
Use cases: V2X (TR38.845), public safety (TR38.845), commercial (TS22.261), IIOT (TS22.104)
Spectrum: ITS, licensed

The SID will identify specific target performance requirements to be considered for the evaluation based on existing 3GPP work and inputs from industry forums. The SID will define evaluation methodology with which to evaluate sidelink positioning for the use cases and coverage scenarios, reusing existing methodologies from sidelink communication and from positioning as much as possible.

The SID will study and evaluate performance and feasibility of potential solutions for sidelink positioning, considering relative positioning, ranging and absolute positioning. For example, the SID may: evaluate bandwidth requirement needed to meet the identified accuracy requirements: study positioning methods (e.g., TDOA, RTT, AOA/D, etc.) including combination of sidelink positioning measurements with other RAT dependent positioning measurements (e.g., Uu based measurements): study sidelink reference signals for positioning purposes from physical layer perspective, including signal design, resource allocation, measurements, associated procedures, etc., reusing existing reference signals, procedures, etc. from sidelink communication and from positioning as much as possible; and study positioning architecture and signaling procedures (e.g., configuration, measurement reporting, etc.) to enable sidelink positioning covering both UE based and network based positioning.

There currently exist certain challenges. For example, current solutions for ranging require a signal exchange for round trip time (RTT) measurements between devices to compute range, which can be resource consuming (time and bandwidth). Doing ranging in this way, potentially between a large number of devices, is not scalable nor resource efficient.

### SUMMARY

As described above, certain challenges currently exist with sidelink ranging. Certain aspects of the present disclosure and their embodiments may provide solutions to these or other challenges.

For example, particular embodiments include scalable and resource efficient sidelink ranging for devices attached to a cellular network by using timing advance (TA) information for the involved devices. Additionally, particular embodiments use a single transmission from a first device to a set of other devices that perform time-of-arrival (ToA) measurements, with transmission and measurements performed with uplink timing. The TA information and the ToA measurements are then collected and used for computing the time-of-flight (ToF) between the first device and the other devices. From ToF the range is computed. Particular embodiments may also derive the TA using a sidelink procedure that also helps the sidelink transmissions to be time aligned/synchronized when user equipment (UEs) are in an out of coverage scenario.

In general, particular embodiments use device specific TA information, together with ToA measurements, to compute the range between a first device and a set of other devices. The signal transmission and measurements are performed using these device specific TAs.

According to some embodiments, a method performed by a first wireless device comprises determining to perform a ranging procedure with respect to a second wireless device; transmitting a reference signal using uplink TA information; and receiving a ranging report from a location function (e.g., location management function (LMF), network node, wireless device, etc.). The ranging report is based at least upon the TA information used for transmitting the reference signal and a measurement of the transmitted reference signal by the second wireless device.

In particular embodiments, the method further comprises transmitting a request to perform the ranging procedure to the location function.

In particular embodiments, determining to perform the ranging procedure is in response to receiving an indication to perform the ranging procedure from the location function. The indication to perform the ranging procedure may comprise an indication of transmission resources to use for transmitting the reference signal.

In particular embodiments, the TA information comprises one TA parameter of a plurality of TA parameters for the first wireless device (e.g., when using one of multiple possible transmission points).

In particular embodiments, the method further comprises requesting a TA report (e.g., from the base station.

According to some embodiments, a method performed by a second wireless device comprises: receiving an indication to perform a ranging procedure with respect to a first wireless device; measuring a ToA of a reference signal received from the first wireless device; and transmitting a ranging report. The ranging report based on the TA information and the ToA measurement.

In particular embodiments, the indication to perform the ranging procedure is received from a location function and transmitting the ranging report comprises transmitting ToA measurement and TA information to the location function.

In particular embodiments, the indication to perform the ranging procedure is received from the first wireless device (e.g., out-of-coverage scenario) and transmitting the ranging report comprises determining a distance between the first wireless device and the second wireless device based on the TA information for from at least the second first wireless device and the ToA measurement and transmitting the ranging report to the first wireless device.

In particular embodiments, the indication to perform the ranging procedure comprises an indication of transmission resources to use for performing the ToA measurement on the reference signal.

In particular embodiments, the TA information comprises one TA parameter of a plurality of TA parameters for the second wireless device.

In particular embodiments, the method further comprises measuring an angle-of-arrival (AoA) of the reference signal received from the first wireless device. The ranging report is further based on the AoA.

According to some embodiments, a wireless device comprises processing circuitry operable to perform any of the wireless device methods described above.

Also disclosed is a computer program product comprising a non-transitory computer readable medium storing computer readable program code, the computer readable program code operable, when executed by processing circuitry to perform any of the methods performed by the wireless device described above.

According to some embodiments, a method performed by a network node (e.g., LMF) comprises: transmitting an indication to perform a ranging procedure between a first wireless device and a second wireless device: receiving TA information for at least the first wireless device: receiving a ToA measurement for a reference signal transmitted from the first wireless device to the second wireless device; and determining a distance between the first wireless device and the second wireless device based on the TA information for the first wireless device and the ToA measurement.

In particular embodiments, the method further comprises transmitting a ranging report to the first wireless device. The ranging report comprises an indication of the determined distance between the first wireless device and the second wireless device.

In particular embodiments, the method further comprises receiving a request to perform the ranging procedure from the first wireless device.

In particular embodiments, the indication to perform the ranging procedure comprises a request to perform ToA measurement and is transmitted to the second wireless device. The indication to perform the ranging procedure may comprise an indication of transmission resources to use for transmitting the reference signal and/or perform the ToA measurement.

In particular embodiments, the method further comprises receiving TA information for the second wireless device and determining the distance between the first wireless device and the second wireless device is further based on the TA information for the second wireless device.

In particular embodiments, the TA information for the first wireless device and/or the second wireless device comprises at least one TA parameter of a plurality of TA parameters for the first wireless device and/or the second wireless device respectively.

In particular embodiments, receiving the TA information comprises receiving a TA report from a base station.

According to some embodiments, a network node comprises processing circuitry operable to perform any of the network node methods described above.

Also disclosed is a computer program product comprising a non-transitory computer readable medium storing computer readable program code, the computer readable program code operable, when executed by processing circuitry to perform any of the methods performed by the network node described above.

Certain embodiments may provide one or more of the following technical advantages. For example, particular embodiments use the timing mechanisms of the network, such as the TA mechanisms and signaling, to achieve scalable and resource efficient sidelink ranging for devices attached to a cellular network.

### BRIEF DESCRIPTION OF THE DRAWINGS

For a more complete understanding of the disclosed embodiments and their features and advantages, reference is now made to the following description, taken in conjunction with the accompanying drawings, in which:

FIG. 1 is a network diagram illustrating communication scenarios for sidelink communication and positioning;

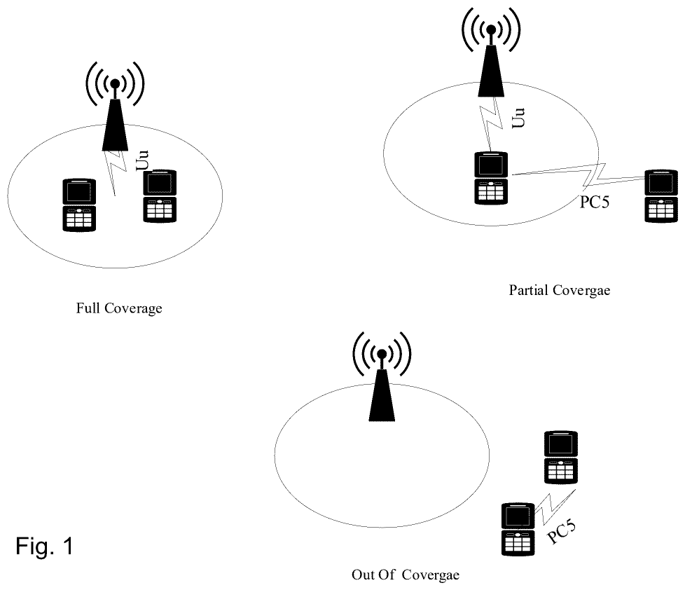

FIG. 2 is a flow chart illustrating steps performed by particular embodiments from the network perspective:

FIG. 3 is a flow chart illustrating steps performed by particular embodiments from the user equipment (UE) perspective:

FIG. 4 is a network diagram illustrating a system overview with gNBs, UEs, and respective communication interfaces:

FIG. 5 is a timing diagram illustrating an example ranging procedure:

FIG. 6 is a sequence diagram illustrating an example embodiment assuming that ranging is initiated by a first UE and involves a second UE:

FIG. 7 is a sequence diagram illustrating an example UE based ranging procedure with network assistance:

FIG. 8 is a flow chart illustrating external-node-triggered ranging with network assistance, according to a particular embodiment;

FIG. 9 is a block diagram illustrating an example wireless network:

FIG. 10 illustrates an example user equipment, according to certain embodiments:

FIG. 11A is flowchart illustrating an example method in a first wireless device, according to certain embodiments:

FIG. 11B is flowchart illustrating an example method in a second wireless device, according to certain embodiments:

FIG. 12 is flowchart illustrating an example method in a network node, according to certain embodiments:

FIG. 13 illustrates a schematic block diagram of a network node and a wireless device in a wireless network, according to certain embodiments:

FIG. 14 illustrates an example virtualization environment, according to certain embodiments:

FIG. 15 illustrates an example telecommunication network connected via an intermediate network to a host computer, according to certain embodiments; and

FIG. 16 illustrates an example host computer communicating via a base station with a user equipment over a partially wireless connection, according to certain embodiments.

### DETAILED DESCRIPTION

As described above, certain challenges currently exist with sidelink ranging. Certain aspects of the present disclosure and their embodiments may provide solutions to these or other challenges. In general, particular embodiments use device specific timing advance (TA) information, together with time-of-arrival (ToA) measurements, to compute the range between a first device and a set of other devices. The signal transmission and measurements are performed using the device specific TAs.

Particular embodiments are described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

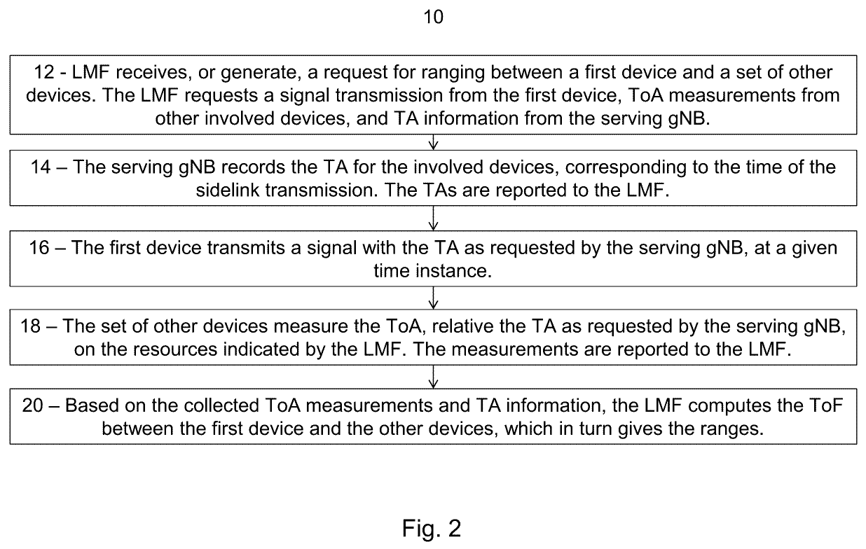

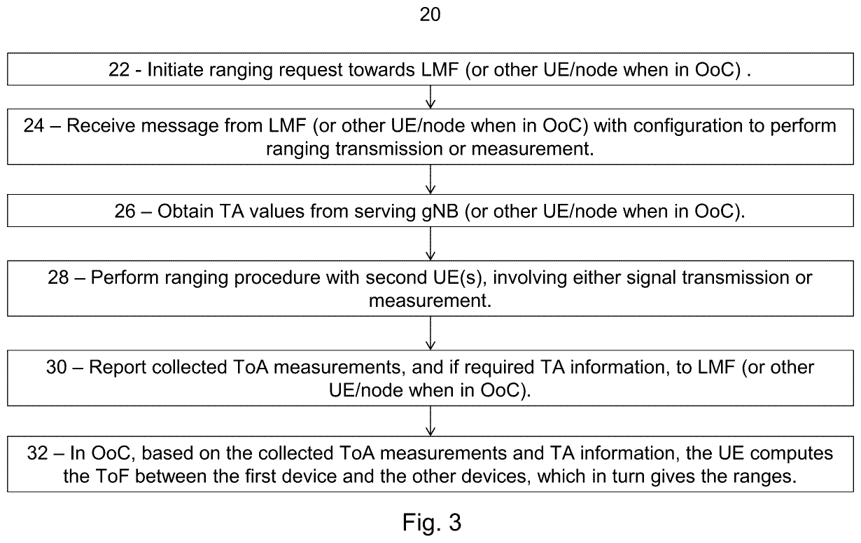

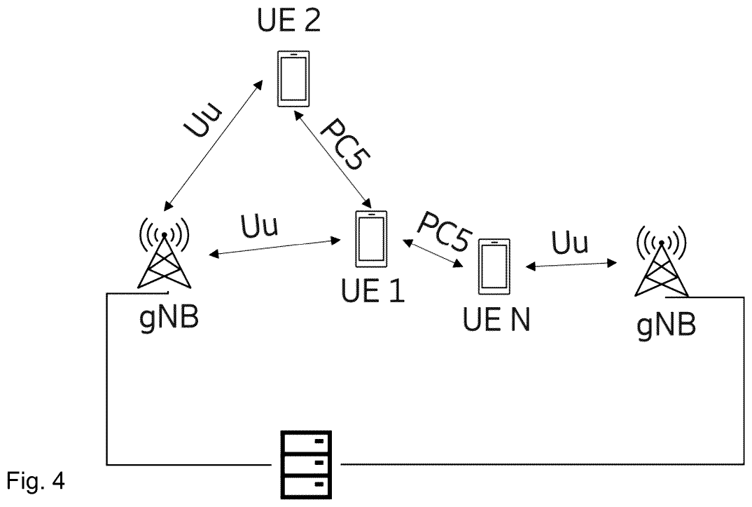

FIGS. 2 and 3 illustrate particular embodiments at a high level. The embodiments are then described in more detail with respect to FIGS. 4-8.

FIG. 2 is a flow chart illustrating steps performed by particular embodiments from the network perspective, where the Location Management Function (LMF) is assumed to be the responsible network node, but acknowledging that a different node, e.g., gNB or UE, may be used in implementation.

In method 10, the network node performs step 12, where the network node (e.g., LMF) receives, or generates, a request for ranging between a first device (e.g., UE) and a set of other devices (e.g., UEs). The network node requests a signal transmission from the first device, ToA measurements from other involved devices, and TA information from the serving gNB.

At step 14, the serving gNB records the TA for the involved devices, corresponding to the time of the sidelink transmission. The serving gNB reports the TAs to the LMF.

At step 16, the first device transmits a signal with the TA as requested by the serving gNB, at a given time instance.

At step 18, the set of other devices measure the ToA, relative to the TA as requested by the serving gNB, on the resources indicated by the LMF. The measurements are reported to the LMF.

At step 20, based on the collected ToA measurements and TA information, the LMF computes the ToF between the first device and the other devices, which in turn gives the ranges.

FIG. 3 is a flow chart illustrating steps performed by particular embodiments from the UE perspective, assuming that the UE has found its ranging counterpart through a sidelink discovery procedure or preconfiguration, alternatively acting according to LMF request:

In method 20, the UE initiates a ranging request towards the LMF (or other UE/node when in OoC) at step 22.

At step 24, the UE receives a message from the LMF (or other UE/node when in OoC) with configuration to perform ranging transmission or measurement.

At step 26, the UE obtains TA values from serving gNB (or other UE/node when in OoC).

At step 28, the UE performs a ranging procedure with second UE(s), involving either signal transmission or measurement.

At step 30, the UE reports collected ToA measurements, and if required TA information, to the LMF (or other UE/node when in OoC).

At step 32, in OoC, based on the collected ToA measurements and TA information, the UE computes the ToF between the first device and the other devices, which in turn gives the ranges.

FIG. 4 is a network diagram illustrating a system overview with gNBs, user equipment (UEs), and respective communication interfaces. The example system illustrated in FIG. 4 consists of a wireless network with one or several network nodes (e.g., transmission reception point (TRP), base station, gNBs, etc.) connected to a core network (e.g., access and mobility management function (AMF) etc.). The network nodes (e.g., TRP, BS, gNBs, etc.) are assumed to be time synchronized with a tolerable error (what is tolerable depends on accuracy requirement, which is use case dependent).

Alternatively, the nodes are unsynchronized but capable of estimating the (potentially time varying) timing offsets. A number of devices are attached to the network via the network nodes (e.g., TRP, BS, gNBs, etc.). In some embodiments, devices (e.g., sidelink capable UEs) are in connected mode and have updated timing advance configurations (reflecting their relative distance to the corresponding gNB). In some embodiments, devices (e.g., sidelink capable UEs) may be in low activity Radio Resource Control (RRC) state (e.g., RRC inactive, RRC idle, etc.). In this case, the UEs may also have updated timing advance configurations (reflecting their relative distance to the corresponding gNB). The involved UEs are capable of communicating with the gNBs (over the Uu interface), and with each other (over the PC5 interface).

An entity in the network is responsible for coordinating signals, collecting measurements and TA information, as well as computing the range between devices. The entity may, in general, be a location management function (LMF), but it may be a different node, e.g., a gNB. In the discussion below, the LMF is the responsible entity, but this can be generalized to be any network node.

Ranging is performed between a first device and any other device connected to the network and configured to measure signals transmitted from the first device. A purpose of the ranging procedure may be to obtain ranging between a specific pair of devices, as per request. The request may be placed by the involved devices or a third party. Alternatively, the ranging procedure may be part of a positioning procedure performed by the network. Other use cases may be envisioned.

Some embodiments include network based ranging with UE assistance. A first device is configured to transmit a known signal within a slot, following its uplink slot timing as configured/indicated per TA procedure. A second device, or a number of other devices, is configured to measure the time-of-arrival (ToA) of the known transmitted signal. The measurements may be done relative the device-specific uplink slot timing as configured/indicated per TA procedure. After the measurement is performed, it is reported to and collected by the LMF. The LMF also collects the TA information for the involved devices from the respective gNBs. Additionally, any information regarding timing offset between gNBs is collected.

In some embodiments, the TA value is obtained by aggregating the timing adjustment commands sent to the involved UEs. In some embodiments, the TA from the aggregated UE commands is reported along with an estimate of the excess delay, the latter being the difference between the expected/configured ToA and the actual ToA at the gNB. The excess delay may be estimated using uplink signals, e.g., sounding reference signal (SRS) or demodulation reference signal (DMRS). In some embodiments, the reported TA value is the combination of the aggregated TA and the estimated excess delay. In some embodiments, the TA difference of the first UE and the other UE(s) is reported, i.e., the TA of the first UE is subtracted from the TA of the other UE TAs. This way avoiding explicit reporting of the TA of the first device.

In some embodiments, the devices are configured to measure the angle of arrival (AoA) of the known signal. Additional information on device orientation may also be provided and used, for example, to translate the AoA measurements to a global reference system. The additional information may be used as part of positioning calculations or to enable a service requiring directional information.

In some deployments, a first device may be configured for uplink multi-TRP operation where the first device is served by two or more TRPs that are separated by a large distance. For example, let PD1 denote the propagation delay between TRP1 and the first device, and let PD2 denote the propagation delay between TRP2 and the first device. When the separation between TRP1 and TRP2 is large, the propagation delay difference (PD1−PD2) can be larger than the cyclic prefix (CP) length. In this case, the first device may be configured/indicated with two TAs (i.e., each TA to be used for uplink transmission towards the respective TRP).

In this scenario, a second device, or a number of other devices, may be either configured/indicated with a single TA or two TAs depending on whether the given second device, or the number of other devices, are configured for uplink multi-TRP operation.

Assume that the first device is configured to transmit a known signal within a slot, following an uplink slot timing corresponding to one of its two configured/indicated TAs. Further assume that the second device, or the number of other devices, are configured to measure the ToA of the known transmitted signal.

In one set of embodiments, when the second device, or the number of other devices, are configured/indicated with a single TA, then following procedures are followed.

Because there are two TAs configured/indicated for the first device, information on which of the two TAs was used for the transmission of the known signal may be reported by the first device directly to the LMF. Alternatively, information on which of the two TAs was used for the transmission of the known signal is reported to the serving gNB by the first device, and the serving gNB then reports this information to the LMF.

The measurements may be performed by the second device, or the number of other devices, relative to the device-specific uplink slot timing as configured/indicated per TA procedure using the single TA.

After the measurement is performed by the second device, the measurement is reported to and collected by the LMF. The LMF also collects the TA information for the second device, or the number of other devices, from the respective gNBs. Additionally, any information regarding timing offset between gNBs may be collected.

In another set of embodiments, when the second device, or the number of other devices, are also configured/indicated with two TAs, then the following procedures are followed.

Because there are two TAs configured/indicated for the first device, information on which of the two TAs was used for the transmission of the known signal may be reported by the first device directly to the LMF. Alternatively, information on which of the two TAs was used for the transmission of the known signal is reported to the serving gNB by the first device, and the serving gNB then reports this information to the LMF.

The measurements may be performed by the second device, or the number of other devices, relative to the device-specific uplink slot timing as configured/indicated per TA procedure using one of the two configured/indicated TAs.

After the measurement is performed by the second device, the measurement is reported to and collected by the LMF.

Because there are two TAs configured/indicated for the second device, information on which of the two TAs was used for the device-specific uplink slot timing when performing the measurement may be reported by the second device, or the number of other devices directly to the LMF. Alternatively, information on which of the two TAs was used for the device-specific uplink slot timing when performing the measurement is reported to the serving gNB of the respective device, and the respective serving gNB then reports this information to the LMF.

Additionally, information regarding timing offset between gNBs may be collected.

Some embodiments include UE based ranging with network assistance. In some embodiments, the measurements and signal exchange are made without network involvement. Assume two devices, both connected to a network and having their TA recorded. A sidelink transmission is made from one device to the other, following the uplink timing given by TA. The ToA is measured at the second device following it's configured TA. The measurements are then shared amongst the devices, or with a third entity. Note that any spectrum resources accessible to the devices for sidelink transmissions with given timing can be used, e.g., unlicensed spectrum.

In some embodiments, the UE requests a report from the serving gNB, or in some embodiments the LMF, on any excess delay at the gNB.

In some embodiments, the devices report the cell ID for which their TA is valid along with the TA and ToA measurement. This is done to verify that the two devices are sharing the same TRP as reference for TA.

In some embodiments, if the two UEs belong to different cells/gNBs with a (known/estimated) difference in uplink timing, the UEs may request a report on the difference. Alternatively, the reported TA values may be adjusted to correspond to the timing at the gNB serving the first device that is performing the sidelink transmission.

Note that the above procedures may be extended to involve multiple receiving UEs, thus achieving ranging between one UE to a multiple of other UEs.

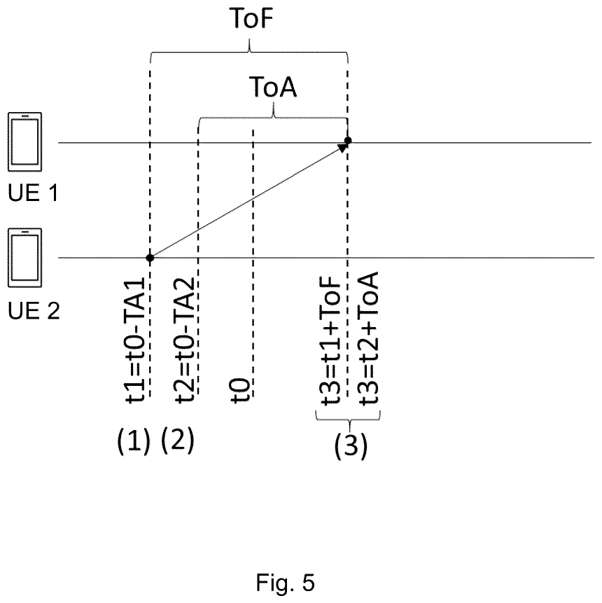

After the measurements have been collected by the LMF, the ranges between the first device and the other devices can be computed. An example is illustrated in FIG. 5.

FIG. 5 is a timing diagram illustrating an example ranging procedure. Referring to FIG. 5, the first device transmits a signal at time instance t1, which is the start of the uplink symbol for UE1 given timing advance TA1 from the gNB. A second UE measures the ToA at t3, which is relative to its uplink timing starting at t2. The relationship between the ToA, ToF, t1, t2, and t3 is then given by

$$\{ \begin{matrix}t 3 = t 1 + ToF \\ t 3 = t 2 + ToA\end{matrix}$$

Note that t1=t0−TA1 and t2=t0−TA2, with TA1 and TA2 being the aggregated timing advances for the first and second device, respectively, and to being the reference time at the gNB corresponding to the expected start of the uplink symbol at the gNB. The ToF can now be solved for, yielding

$$ToF = ToA + t 2 - t 1 = ToA - ( TA 2 - TA 1 ) .$$

If the second device is served by a different gNB, with the reference time t′0=t0+dt relative the first gNB, the ToF may be computed as

$$ToF = ToA + ( {t}^{′} 0 - TA 2 ) - ( t 0 - TA 1 ) = ToA - ( TA 2 - TA 1 ) + dt .$$

The range is then given by r=ToF*speed_of_light.

Some embodiments include network based ranging with UE assistance. The procedures required for the ranging solution may be implemented in different ways.

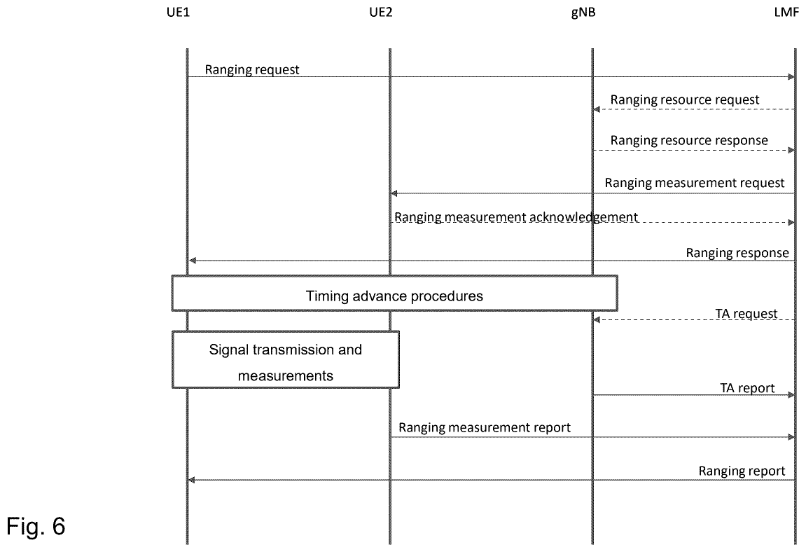

FIG. 6 is a sequence diagram illustrating an example embodiment assuming that ranging is initiated by a first UE and involves a second UE. A generalization to multiple UEs is straight forward. Additionally, the ranging may equally be initiated by a third UE, network node, or a network external entity.

The first UE initiates the procedures by sending a ranging request to the LMF. The request may contain, but is not restricted to contain, information about which UE(s) are requested to be part of the ranging procedure, quality of service information (e.g., accuracy requirements), and/or serving gNB.

The LMF may, if required, perform a ranging resource request procedure with serving gNBs to secure sidelink resources to be used.

The LMF then sends a ranging measurement request to the second UE, which may send an acknowledgement message to accept participation. The request includes which resources on which to measure the ToA and any other required configuration data.

As a response to the UE1 ranging request, the LMF responds with a ranging response. The response provides an acknowledgement for the requested event (or refusal of the same), along with transmission configuration.

During the course of events, the TA procedures make sure the timing information is up to date. Potentially, in some embodiments, the gNB takes extra measures as part of the ranging event to make sure TA is accurate.

After the involved UEs have received the resource configuration, the ranging event can take place with transmission of a signal from UE1 and ToA measurements at the other device.

In parallel with the sidelink transmission, the serving gNBs may collect the timing advance information and report to the LMF in the form of a TA report. Depending on configuration, the report may be a response to an explicit TA request from the LMF.

After UE2 has collected the measurements based on the sidelink signal from the first UE, a report is sent to the LMF which then computes the range information and shares it with UE1 and or other requesting entities.

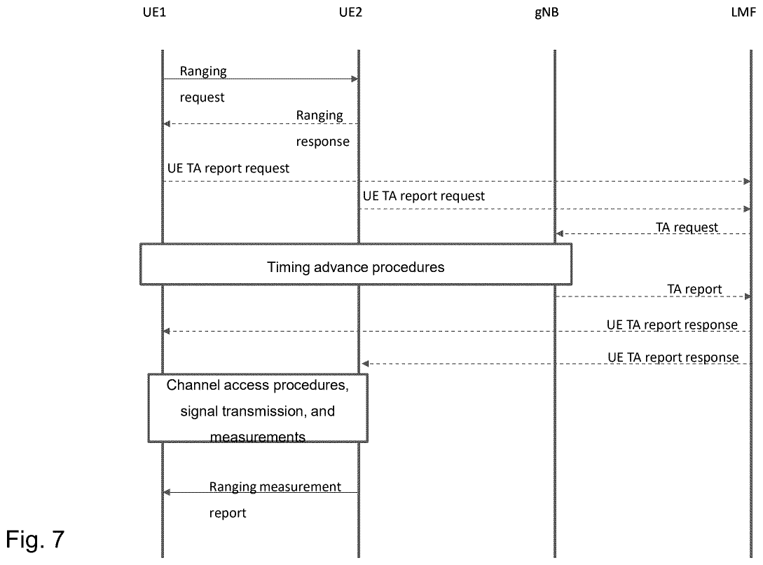

Some embodiments include UE based ranging with network assistance. An example is illustrated in FIG. 7.

FIG. 7 is a sequence diagram illustrating an example UE based ranging procedure with network assistance. The illustrated example is restricted to two UEs, but particular embodiments also apply to multiple receiving UEs.

The first UE transmits a ranging request to the second UE. The two UEs may have performed a discovery procedure to allow a direct unicast transmission, or the request may be part of a discovery procedure.

Depending on configuration or implementation, the second UE provides a ranging response acknowledging the participation in the event, potentially providing additional information to support the ranging event, e.g., device capabilities.

Depending on implementation, network support, or required accuracy of the ranging event, the UEs may request a TA report from the LMF, which in turn may trigger a request to the involved gNBs to update TA, acquire additional TA information, and/or report the current TA information. This information is then reported to the devices. In some embodiments, the first UE may request TA information for all involved UEs.

Following the updated TA information as a result of the TA procedures, UE1 transmits a signal and UE2 perform measurements. Depending on the system used for sidelink measurements, additional procedures for channel access may be required.

After UE2 has performed the required/agreed measurements, a ranging measurement report is provided to UE1, also containing the TA information, unless already provided by other means.

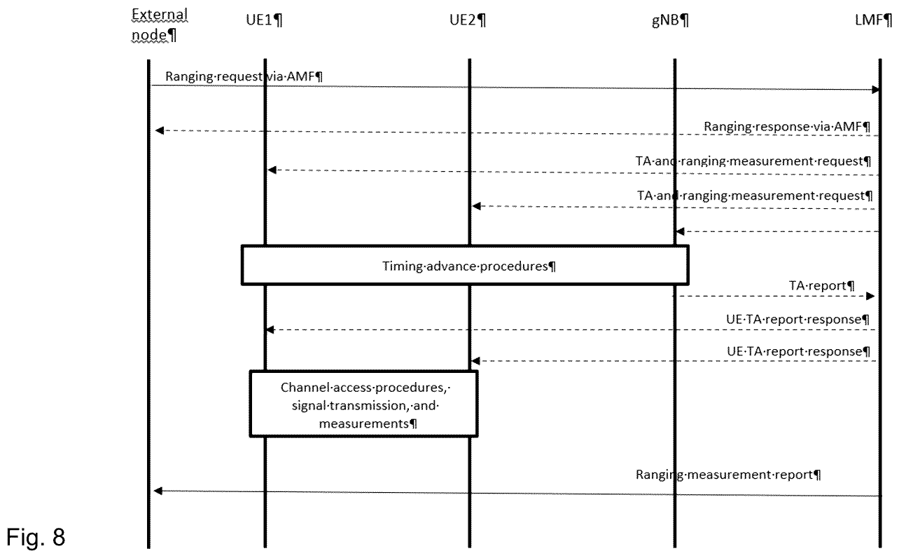

Some embodiments include external-node-triggered ranging with network assistance. An example is illustrated in FIG. 8.

FIG. 8 is a flow chart illustrating external-node-triggered ranging with network assistance, according to a particular embodiment. An external node may send a request to the network for ranging of at least two UEs, or the ranging of one UE and at least one other UE. The AMF in the network receives the ranging measurement request and then forwards the measurement request to LMF.

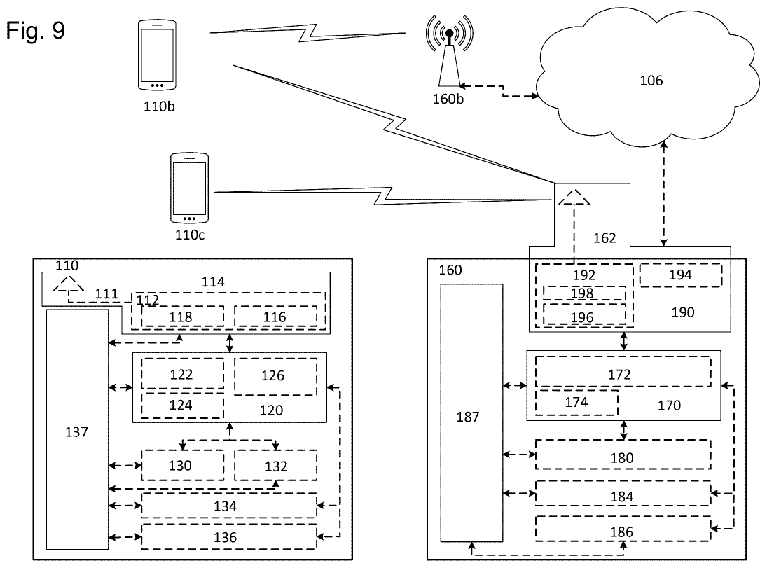

FIG. 9 illustrates an example wireless network, according to certain embodiments. The wireless network may comprise and/or interface with any type of communication, telecommunication, data, cellular, and/or radio network or other similar type of system. In some embodiments, the wireless network may be configured to operate according to specific standards or other types of predefined rules or procedures. Thus, particular embodiments of the wireless network may implement communication standards, such as Global System for Mobile Communications (GSM), Universal Mobile Telecommunications System (UMTS), Long Term Evolution (LTE), and/or other suitable 2G, 3G, 4G, or 5G standards: wireless local area network (WLAN) standards, such as the IEEE 802.11 standards; and/or any other appropriate wireless communication standard, such as the Worldwide Interoperability for Microwave Access (WiMax), Bluetooth, Z-Wave and/or ZigBee standards.

Network 106 may comprise one or more backhaul networks, core networks, IP networks, public switched telephone networks (PSTNs), packet data networks, optical networks, wide-area networks (WANs), local area networks (LANs), wireless local area networks (WLANs), wired networks, wireless networks, metropolitan area networks, and other networks to enable communication between devices.

Network node 160 and WD 110 comprise various components described in more detail below. These components work together to provide network node and/or wireless device functionality, such as providing wireless connections in a wireless network. In different embodiments, the wireless network may comprise any number of wired or wireless networks, network nodes, base stations, controllers, wireless devices, relay stations, and/or any other components or systems that may facilitate or participate in the communication of data and/or signals whether via wired or wireless connections.

As used herein, network node refers to equipment capable, configured, arranged and/or operable to communicate directly or indirectly with a wireless device and/or with other network nodes or equipment in the wireless network to enable and/or provide wireless access to the wireless device and/or to perform other functions (e.g., administration) in the wireless network.

Examples of network nodes include, but are not limited to, access points (APs) (e.g., radio access points), base stations (BSs) (e.g., radio base stations, Node Bs, evolved Node Bs (eNBs) and NR NodeBs (gNBs)). Base stations may be categorized based on the amount of coverage they provide (or, stated differently, their transmit power level) and may then also be referred to as femto base stations, pico base stations, micro base stations, or macro base stations.

A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS). Yet further examples of network nodes include multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), core network nodes (e.g., MSCs, MMEs), O&M nodes, OSS nodes, SON nodes, positioning nodes (e.g., E-SMLCs), and/or MDTs.

As another example, a network node may be a virtual network node as described in more detail below. More generally, however, network nodes may represent any suitable device (or group of devices) capable, configured, arranged, and/or operable to enable and/or provide a wireless device with access to the wireless network or to provide some service to a wireless device that has accessed the wireless network.

In FIG. 9, network node 160 includes processing circuitry 170, device readable medium 180, interface 190, auxiliary equipment 184, power source 186, power circuitry 187, and antenna 162. Although network node 160 illustrated in the example wireless network of FIG. 9 may represent a device that includes the illustrated combination of hardware components, other embodiments may comprise network nodes with different combinations of components.

It is to be understood that a network node comprises any suitable combination of hardware and/or software needed to perform the tasks, features, functions and methods disclosed herein. Moreover, while the components of network node 160 are depicted as single boxes located within a larger box, or nested within multiple boxes, in practice, a network node may comprise multiple different physical components that make up a single illustrated component (e.g., device readable medium 180 may comprise multiple separate hard drives as well as multiple RAM modules).

Similarly, network node 160 may be composed of multiple physically separate components (e.g., a NodeB component and a RNC component, or a BTS component and a BSC component, etc.), which may each have their own respective components. In certain scenarios in which network node 160 comprises multiple separate components (e.g., BTS and BSC components), one or more of the separate components may be shared among several network nodes. For example, a single RNC may control multiple NodeB's. In such a scenario, each unique NodeB and RNC pair, may in some instances be considered a single separate network node.

In some embodiments, network node 160 may be configured to support multiple radio access technologies (RATs). In such embodiments, some components may be duplicated (e.g., separate device readable medium 180 for the different RATs) and some components may be reused (e.g., the same antenna 162 may be shared by the RATs). Network node 160 may also include multiple sets of the various illustrated components for different wireless technologies integrated into network node 160, such as, for example, GSM, WCDMA, LTE, NR, WiFi, or Bluetooth wireless technologies. These wireless technologies may be integrated into the same or different chip or set of chips and other components within network node 160.

Processing circuitry 170 is configured to perform any determining, calculating, or similar operations (e.g., certain obtaining operations) described herein as being provided by a network node. These operations performed by processing circuitry 170 may include processing information obtained by processing circuitry 170 by, for example, converting the obtained information into other information, comparing the obtained information or converted information to information stored in the network node, and/or performing one or more operations based on the obtained information or converted information, and as a result of said processing making a determination.

Processing circuitry 170 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 160 components, such as device readable medium 180, network node 160 functionality.

For example, processing circuitry 170 may execute instructions stored in device readable medium 180 or in memory within processing circuitry 170. Such functionality may include providing any of the various wireless features, functions, or benefits discussed herein. In some embodiments, processing circuitry 170 may include a system on a chip (SOC).

In some embodiments, processing circuitry 170 may include one or more of radio frequency (RF) transceiver circuitry 172 and baseband processing circuitry 174. In some embodiments, radio frequency (RF) transceiver circuitry 172 and baseband processing circuitry 174 may be on separate chips (or sets of chips), boards, or units, such as radio units and digital units. In alternative embodiments, part or all of RF transceiver circuitry 172 and baseband processing circuitry 174 may be on the same chip or set of chips, boards, or units

In certain embodiments, some or all of the functionality described herein as being provided by a network node, base station, eNB or other such network device may be performed by processing circuitry 170 executing instructions stored on device readable medium 180 or memory within processing circuitry 170. In alternative embodiments, some or all of the functionality may be provided by processing circuitry 170 without executing instructions stored on a separate or discrete device readable medium, such as in a hard-wired manner. In any of those embodiments, whether executing instructions stored on a device readable storage medium or not, processing circuitry 170 can be configured to perform the described functionality. The benefits provided by such functionality are not limited to processing circuitry 170 alone or to other components of network node 160 but are enjoyed by network node 160 as a whole, and/or by end users and the wireless network generally.

Device readable medium 180 may comprise any form of volatile or non-volatile computer readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device readable and/or computer-executable memory devices that store information, data, and/or instructions that may be used by processing circuitry 170. Device readable medium 180 may store any suitable instructions, data or information, including a computer program, software, an application including one or more of logic, rules, code, tables, etc. and/or other instructions capable of being executed by processing circuitry 170 and, utilized by network node 160. Device readable medium 180 may be used to store any calculations made by processing circuitry 170 and/or any data received via interface 190. In some embodiments, processing circuitry 170 and device readable medium 180 may be considered to be integrated.

Interface 190 is used in the wired or wireless communication of signaling and/or data between network node 160, network 106, and/or WDs 110. As illustrated, interface 190 comprises port(s)/terminal(s) 194 to send and receive data, for example to and from network 106 over a wired connection. Interface 190 also includes radio front end circuitry 192 that may be coupled to, or in certain embodiments a part of, antenna 162.

Radio front end circuitry 192 comprises filters 198 and amplifiers 196. Radio front end circuitry 192 may be connected to antenna 162 and processing circuitry 170. Radio front end circuitry may be configured to condition signals communicated between antenna 162 and processing circuitry 170. Radio front end circuitry 192 may receive digital data that is to be sent out to other network nodes or WDs via a wireless connection. Radio front end circuitry 192 may convert the digital data into a radio signal having the appropriate channel and bandwidth parameters using a combination of filters 198 and/or amplifiers 196. The radio signal may then be transmitted via antenna 162. Similarly, when receiving data, antenna 162 may collect radio signals which are then converted into digital data by radio front end circuitry 192. The digital data may be passed to processing circuitry 170. In other embodiments, the interface may comprise different components and/or different combinations of components.

In certain alternative embodiments, network node 160 may not include separate radio front end circuitry 192, instead, processing circuitry 170 may comprise radio front end circuitry and may be connected to antenna 162 without separate radio front end circuitry 192. Similarly, in some embodiments, all or some of RF transceiver circuitry 172 may be considered a part of interface 190. In still other embodiments, interface 190 may include one or more ports or terminals 194, radio front end circuitry 192, and RF transceiver circuitry 172, as part of a radio unit (not shown), and interface 190 may communicate with baseband processing circuitry 174, which is part of a digital unit (not shown).

Antenna 162 may include one or more antennas, or antenna arrays, configured to send and/or receive wireless signals. Antenna 162 may be coupled to radio front end circuitry 192 and may be any type of antenna capable of transmitting and receiving data and/or signals wirelessly. In some embodiments, antenna 162 may comprise one or more omni-directional, sector or panel antennas operable to transmit/receive radio signals between, for example, 2 GHz and 66 GHZ. An omni-directional antenna may be used to transmit/receive radio signals in any direction, a sector antenna may be used to transmit/receive radio signals from devices within a particular area, and a panel antenna may be a line of sight antenna used to transmit/receive radio signals in a relatively straight line. In some instances, the use of more than one antenna may be referred to as MIMO. In certain embodiments, antenna 162 may be separate from network node 160 and may be connectable to network node 160 through an interface or port.

Antenna 162, interface 190, and/or processing circuitry 170 may be configured to perform any receiving operations and/or certain obtaining operations described herein as being performed by a network node. Any information, data and/or signals may be received from a wireless device, another network node and/or any other network equipment. Similarly, antenna 162, interface 190, and/or processing circuitry 170 may be configured to perform any transmitting operations described herein as being performed by a network node. Any information, data and/or signals may be transmitted to a wireless device, another network node and/or any other network equipment.

Power circuitry 187 may comprise, or be coupled to, power management circuitry and is configured to supply the components of network node 160 with power for performing the functionality described herein. Power circuitry 187 may receive power from power source 186. Power source 186 and/or power circuitry 187 may be configured to provide power to the various components of network node 160 in a form suitable for the respective components (e.g., at a voltage and current level needed for each respective component). Power source 186 may either be included in, or external to, power circuitry 187 and/or network node 160.

For example, network node 160 may be connectable to an external power source (e.g., an electricity outlet) via an input circuitry or interface such as an electrical cable, whereby the external power source supplies power to power circuitry 187. As a further example, power source 186 may comprise a source of power in the form of a battery or battery pack which is connected to, or integrated in, power circuitry 187. The battery may provide backup power should the external power source fail. Other types of power sources, such as photovoltaic devices, may also be used.

Alternative embodiments of network node 160 may include additional components beyond those shown in FIG. 9 that may be responsible for providing certain aspects of the network node's functionality, including any of the functionality described herein and/or any functionality necessary to support the subject matter described herein. For example, network node 160 may include user interface equipment to allow input of information into network node 160 and to allow output of information from network node 160. This may allow a user to perform diagnostic, maintenance, repair, and other administrative functions for network node 160.

As used herein, wireless device (WD) refers to a device capable, configured, arranged and/or operable to communicate wirelessly with network nodes and/or other wireless devices. Unless otherwise noted, the term WD may be used interchangeably herein with user equipment (UE). Communicating wirelessly may involve transmitting and/or receiving wireless signals using electromagnetic waves, radio waves, infrared waves, and/or other types of signals suitable for conveying information through air.

In some embodiments, a WD may be configured to transmit and/or receive information without direct human interaction. For instance, a WD may be designed to transmit information to a network on a predetermined schedule, when triggered by an internal or external event, or in response to requests from the network.

Examples of a WD include, but are not limited to, a smart phone, a mobile phone, a cell phone, a voice over IP (VOIP) phone, a wireless local loop phone, a desktop computer, a personal digital assistant (PDA), a wireless cameras, a gaming console or device, a music storage device, a play back appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE). a vehicle-mounted wireless terminal device, etc. A WD may support device-to-device (D2D) communication, for example by implementing a 3GPP standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, a WD may represent a machine or other device that performs monitoring and/or measurements and transmits the results of such monitoring and/or measurements to another WD and/or a network node. The WD may in this case be a machine-to-machine (M2M) device, which may in a 3GPP context be referred to as an MTC device. As one example, the WD may be a UE implementing the 3GPP narrow band internet of things (NB-IoT) standard. Examples of such machines or devices are sensors, metering devices such as power meters, industrial machinery, or home or personal appliances (e.g. refrigerators, televisions, etc.) personal wearables (e.g., watches, fitness trackers, etc.).

In other scenarios, a WD may represent a vehicle or other equipment that is capable of monitoring and/or reporting on its operational status or other functions associated with its operation. A WD as described above may represent the endpoint of a wireless connection, in which case the device may be referred to as a wireless terminal. Furthermore, a WD as described above may be mobile, in which case it may also be referred to as a mobile device or a mobile terminal.

As illustrated, wireless device 110 includes antenna 111, interface 114, processing circuitry 120, device readable medium 130, user interface equipment 132, auxiliary equipment 134, power source 136 and power circuitry 137. WD 110 may include multiple sets of one or more of the illustrated components for different wireless technologies supported by WD 110, such as, for example, GSM, WCDMA, LTE, NR, WiFi, WiMAX, or Bluetooth wireless technologies, just to mention a few. These wireless technologies may be integrated into the same or different chips or set of chips as other components within WD 110.

Antenna 111 may include one or more antennas or antenna arrays, configured to send and/or receive wireless signals, and is connected to interface 114. In certain alternative embodiments, antenna 111 may be separate from WD 110 and be connectable to WD 110 through an interface or port. Antenna 111, interface 114, and/or processing circuitry 120 may be configured to perform any receiving or transmitting operations described herein as being performed by a WD. Any information, data and/or signals may be received from a network node and/or another WD. In some embodiments, radio front end circuitry and/or antenna 111 may be considered an interface.

As illustrated, interface 114 comprises radio front end circuitry 112 and antenna 111. Radio front end circuitry 112 comprise one or more filters 118 and amplifiers 116. Radio front end circuitry 112 is connected to antenna 111 and processing circuitry 120 and is configured to condition signals communicated between antenna 111 and processing circuitry 120. Radio front end circuitry 112 may be coupled to or a part of antenna 111. In some embodiments, WD 110 may not include separate radio front end circuitry 112: rather, processing circuitry 120 may comprise radio front end circuitry and may be connected to antenna 111. Similarly, in some embodiments, some or all of RF transceiver circuitry 122 may be considered a part of interface 114.

Radio front end circuitry 112 may receive digital data that is to be sent out to other network nodes or WDs via a wireless connection. Radio front end circuitry 112 may convert the digital data into a radio signal having the appropriate channel and bandwidth parameters using a combination of filters 118 and/or amplifiers 116. The radio signal may then be transmitted via antenna 111. Similarly, when receiving data, antenna 111 may collect radio signals which are then converted into digital data by radio front end circuitry 112. The digital data may be passed to processing circuitry 120. In other embodiments, the interface may comprise different components and/or different combinations of components.

Processing circuitry 120 may comprise a combination of one or more of a microprocessor, controller, microcontroller, central processing unit, digital signal processor, application-specific integrated circuit, field programmable gate array, or any other suitable computing device, resource, or combination of hardware, software, and/or encoded logic operable to provide, either alone or in conjunction with other WD 110 components, such as device readable medium 130, WD 110 functionality. Such functionality may include providing any of the various wireless features or benefits discussed herein. For example, processing circuitry 120 may execute instructions stored in device readable medium 130 or in memory within processing circuitry 120 to provide the functionality disclosed herein.

As illustrated, processing circuitry 120 includes one or more of RF transceiver circuitry 122, baseband processing circuitry 124, and application processing circuitry 126. In other embodiments, the processing circuitry may comprise different components and/or different combinations of components. In certain embodiments processing circuitry 120 of WD 110 may comprise a SOC. In some embodiments, RF transceiver circuitry 122, baseband processing circuitry 124, and application processing circuitry 126 may be on separate chips or sets of chips.

In alternative embodiments, part or all of baseband processing circuitry 124 and application processing circuitry 126 may be combined into one chip or set of chips, and RF transceiver circuitry 122 may be on a separate chip or set of chips. In still alternative embodiments, part or all of RF transceiver circuitry 122 and baseband processing circuitry 124 may be on the same chip or set of chips, and application processing circuitry 126 may be on a separate chip or set of chips. In yet other alternative embodiments, part or all of RF transceiver circuitry 122, baseband processing circuitry 124, and application processing circuitry 126 may be combined in the same chip or set of chips. In some embodiments, RF transceiver circuitry 122 may be a part of interface 114. RF transceiver circuitry 122 may condition RF signals for processing circuitry 120.

In certain embodiments, some or all of the functionality described herein as being performed by a WD may be provided by processing circuitry 120 executing instructions stored on device readable medium 130, which in certain embodiments may be a computer-readable storage medium. In alternative embodiments, some or all of the functionality may be provided by processing circuitry 120 without executing instructions stored on a separate or discrete device readable storage medium, such as in a hard-wired manner.

In any of those embodiments, whether executing instructions stored on a device readable storage medium or not, processing circuitry 120 can be configured to perform the described functionality. The benefits provided by such functionality are not limited to processing circuitry 120 alone or to other components of WD 110, but are enjoyed by WD 110, and/or by end users and the wireless network generally.

Processing circuitry 120 may be configured to perform any determining, calculating, or similar operations (e.g., certain obtaining operations) described herein as being performed by a WD. These operations, as performed by processing circuitry 120, may include processing information obtained by processing circuitry 120 by, for example, converting the obtained information into other information, comparing the obtained information or converted information to information stored by WD 110, and/or performing one or more operations based on the obtained information or converted information, and as a result of said processing making a determination.

Device readable medium 130 may be operable to store a computer program, software, an application including one or more of logic, rules, code, tables, etc. and/or other instructions capable of being executed by processing circuitry 120. Device readable medium 130 may include computer memory (e.g., Random Access Memory (RAM) or Read Only Memory (ROM)), mass storage media (e.g., a hard disk), removable storage media (e.g., a Compact Disk (CD) or a Digital Video Disk (DVD)), and/or any other volatile or non-volatile, non-transitory device readable and/or computer executable memory devices that store information, data, and/or instructions that may be used by processing circuitry 120. In some embodiments, processing circuitry 120 and device readable medium 130 may be integrated.

User interface equipment 132 may provide components that allow for a human user to interact with WD 110. Such interaction may be of many forms, such as visual, audial, tactile, etc. User interface equipment 132 may be operable to produce output to the user and to allow the user to provide input to WD 110. The type of interaction may vary depending on the type of user interface equipment 132 installed in WD 110. For example, if WD 110 is a smart phone, the interaction may be via a touch screen: if WD 110 is a smart meter, the interaction may be through a screen that provides usage (e.g., the number of gallons used) or a speaker that provides an audible alert (e.g., if smoke is detected).

User interface equipment 132 may include input interfaces, devices and circuits, and output interfaces, devices and circuits. User interface equipment 132 is configured to allow input of information into WD 110 and is connected to processing circuitry 120 to allow processing circuitry 120 to process the input information. User interface equipment 132 may include, for example, a microphone, a proximity or other sensor, keys/buttons, a touch display, one or more cameras, a USB port, or other input circuitry. User interface equipment 132 is also configured to allow output of information from WD 110, and to allow processing circuitry 120 to output information from WD 110. User interface equipment 132 may include, for example, a speaker, a display, vibrating circuitry, a USB port, a headphone interface, or other output circuitry. Using one or more input and output interfaces, devices, and circuits, of user interface equipment 132, WD 110 may communicate with end users and/or the wireless network and allow them to benefit from the functionality described herein.

Auxiliary equipment 134 is operable to provide more specific functionality which may not be generally performed by WDs. This may comprise specialized sensors for doing measurements for various purposes, interfaces for additional types of communication such as wired communications etc. The inclusion and type of components of auxiliary equipment 134 may vary depending on the embodiment and/or scenario.

Power source 136 may, in some embodiments, be in the form of a battery or battery pack. Other types of power sources, such as an external power source (e.g., an electricity outlet), photovoltaic devices or power cells, may also be used. WD 110 may further comprise power circuitry 137 for delivering power from power source 136 to the various parts of WD 110 which need power from power source 136 to carry out any functionality described or indicated herein. Power circuitry 137 may in certain embodiments comprise power management circuitry.

Power circuitry 137 may additionally or alternatively be operable to receive power from an external power source: in which case WD 110 may be connectable to the external power source (such as an electricity outlet) via input circuitry or an interface such as an electrical power cable. Power circuitry 137 may also in certain embodiments be operable to deliver power from an external power source to power source 136. This may be, for example, for the charging of power source 136. Power circuitry 137 may perform any formatting, converting, or other modification to the power from power source 136 to make the power suitable for the respective components of WD 110 to which power is supplied.

Although the subject matter described herein may be implemented in any appropriate type of system using any suitable components, the embodiments disclosed herein are described in relation to a wireless network, such as the example wireless network illustrated in FIG. 9. For simplicity, the wireless network of FIG. 9 only depicts network 106, network nodes 160 and 160b, and WDs 110, 110b, and 110c. In practice, a wireless network may further include any additional elements suitable to support communication between wireless devices or between a wireless device and another communication device, such as a landline telephone, a service provider, or any other network node or end device. Of the illustrated components, network node 160 and wireless device (WD) 110 are depicted with additional detail. The wireless network may provide communication and other types of services to one or more wireless devices to facilitate the wireless devices' access to and/or use of the services provided by, or via, the wireless network.

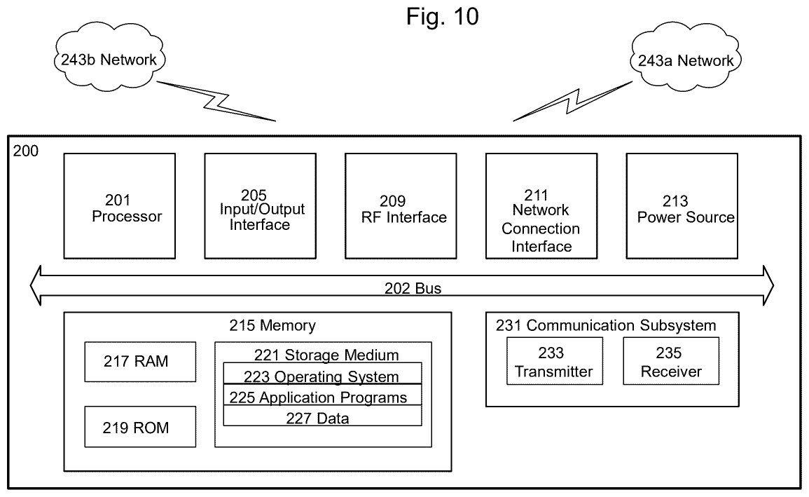

FIG. 10 illustrates an example user equipment, according to certain embodiments. As used herein, a user equipment or UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter). UE 200 may be any UE identified by the 3^{rd} Generation Partnership Project (3GPP), including a NB-IoT UE, a machine type communication (MTC) UE, and/or an enhanced MTC (eMTC) UE. UE 200, as illustrated in FIG. 10, is one example of a WD configured for communication in accordance with one or more communication standards promulgated by the 3rd Generation Partnership Project (3GPP), such as 3GPP's GSM, UMTS, LTE, and/or 5G standards. As mentioned previously, the term WD and UE may be used interchangeable. Accordingly, although FIG. 10 is a UE, the components discussed herein are equally applicable to a WD, and vice-versa.

In FIG. 10, UE 200 includes processing circuitry 201 that is operatively coupled to input/output interface 205, radio frequency (RF) interface 209, network connection interface 211, memory 215 including random access memory (RAM) 217, read-only memory (ROM) 219, and storage medium 221 or the like, communication subsystem 231, power source 213, and/or any other component, or any combination thereof. Storage medium 221 includes operating system 223, application program 225, and data 227. In other embodiments, storage medium 221 may include other similar types of information. Certain UEs may use all the components shown in FIG. 10, or only a subset of the components. The level of integration between the components may vary from one UE to another UE. Further, certain UEs may contain multiple instances of a component, such as multiple processors, memories, transceivers, transmitters, receivers, etc.

In FIG. 10, processing circuitry 201 may be configured to process computer instructions and data. Processing circuitry 201 may be configured to implement any sequential state machine operative to execute machine instructions stored as machine-readable computer programs in the memory, such as one or more hardware-implemented state machines (e.g., in discrete logic, FPGA, ASIC, etc.): programmable logic together with appropriate firmware; one or more stored program, general-purpose processors, such as a microprocessor or Digital Signal Processor (DSP), together with appropriate software: or any combination of the above. For example, the processing circuitry 201 may include two central processing units (CPUs). Data may be information in a form suitable for use by a computer.

In the depicted embodiment, input/output interface 205 may be configured to provide a communication interface to an input device, output device, or input and output device. UE 200 may be configured to use an output device via input/output interface 205.

An output device may use the same type of interface port as an input device. For example, a USB port may be used to provide input to and output from UE 200. The output device may be a speaker, a sound card, a video card, a display, a monitor, a printer, an actuator, an emitter, a smartcard, another output device, or any combination thereof.

UE 200 may be configured to use an input device via input/output interface 205 to allow a user to capture information into UE 200. The input device may include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, another like sensor, or any combination thereof. For example, the input device may be an accelerometer, a magnetometer, a digital camera, a microphone, and an optical sensor.

In FIG. 10, RF interface 209 may be configured to provide a communication interface to RF components such as a transmitter, a receiver, and an antenna. Network connection interface 211 may be configured to provide a communication interface to network 243a. Network 243a may encompass wired and/or wireless networks such as a local-area network (LAN), a wide-area network (WAN), a computer network, a wireless network, a telecommunications network, another like network or any combination thereof. For example, network 243a may comprise a Wi-Fi network. Network connection interface 211 may be configured to include a receiver and a transmitter interface used to communicate with one or more other devices over a communication network according to one or more communication protocols, such as Ethernet, TCP/IP, SONET, ATM, or the like. Network connection interface 211 may implement receiver and transmitter functionality appropriate to the communication network links (e.g., optical, electrical, and the like). The transmitter and receiver functions may share circuit components, software or firmware, or alternatively may be implemented separately.

RAM 217 may be configured to interface via bus 202 to processing circuitry 201 to provide storage or caching of data or computer instructions during the execution of software programs such as the operating system, application programs, and device drivers. ROM 219 may be configured to provide computer instructions or data to processing circuitry 201. For example, ROM 219 may be configured to store invariant low-level system code or data for basic system functions such as basic input and output (I/O), startup, or reception of keystrokes from a key board that are stored in a non-volatile memory.

Storage medium 221 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, storage medium 221 may be configured to include operating system 223, application program 225 such as a web browser application, a widget or gadget engine or another application, and data file 227. Storage medium 221 may store, for use by UE 200, any of a variety of various operating systems or combinations of operating systems.

Storage medium 221 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. Storage medium 221 may allow UE 200 to access computer-executable instructions, application programs or the like, stored on transitory or non-transitory memory media, to off-load data, or to upload data. An article of manufacture, such as one utilizing a communication system may be tangibly embodied in storage medium 221, which may comprise a device readable medium.

In FIG. 10, processing circuitry 201 may be configured to communicate with network 243b using communication subsystem 231. Network 243a and network 243b may be the same network or networks or different network or networks. Communication subsystem 231 may be configured to include one or more transceivers used to communicate with network 243b. For example, communication subsystem 231 may be configured to include one or more transceivers used to communicate with one or more remote transceivers of another device capable of wireless communication such as another WD, UE, or base station of a radio access network (RAN) according to one or more communication protocols, such as IEEE 802.2. CDMA, WCDMA, GSM, LTE, UTRAN, WiMax, or the like. Each transceiver may include transmitter 233 and/or receiver 235 to implement transmitter or receiver functionality, respectively, appropriate to the RAN links (e.g., frequency allocations and the like). Further, transmitter 233 and receiver 235 of each transceiver may share circuit components, software or firmware, or alternatively may be implemented separately.

In the illustrated embodiment, the communication functions of communication subsystem 231 may include data communication, voice communication, multimedia communication, short-range communications such as Bluetooth, near-field communication, location-based communication such as the use of the global positioning system (GPS) to determine a location, another like communication function, or any combination thereof. For example, communication subsystem 231 may include cellular communication, Wi-Fi communication, Bluetooth communication, and GPS communication. Network 243b may encompass wired and/or wireless networks such as a local-area network (LAN), a wide-area network (WAN), a computer network, a wireless network, a telecommunications network, another like network or any combination thereof. For example, network 243b may be a cellular network, a Wi-Fi network, and/or a near-field network. Power source 213 may be configured to provide alternating current (AC) or direct current (DC) power to components of UE 200.

The features, benefits and/or functions described herein may be implemented in one of the components of UE 200 or partitioned across multiple components of UE 200. Further, the features, benefits, and/or functions described herein may be implemented in any combination of hardware, software or firmware. In one example, communication subsystem 231 may be configured to include any of the components described herein. Further, processing circuitry 201 may be configured to communicate with any of such components over bus 202. In another example, any of such components may be represented by program instructions stored in memory that when executed by processing circuitry 201 perform the corresponding functions described herein. In another example, the functionality of any of such components may be partitioned between processing circuitry 201 and communication subsystem 231. In another example, the non-computationally intensive functions of any of such components may be implemented in software or firmware and the computationally intensive functions may be implemented in hardware.

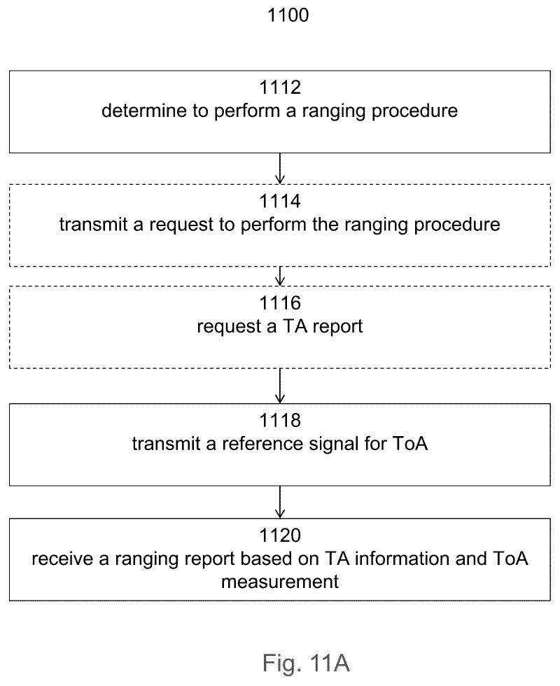

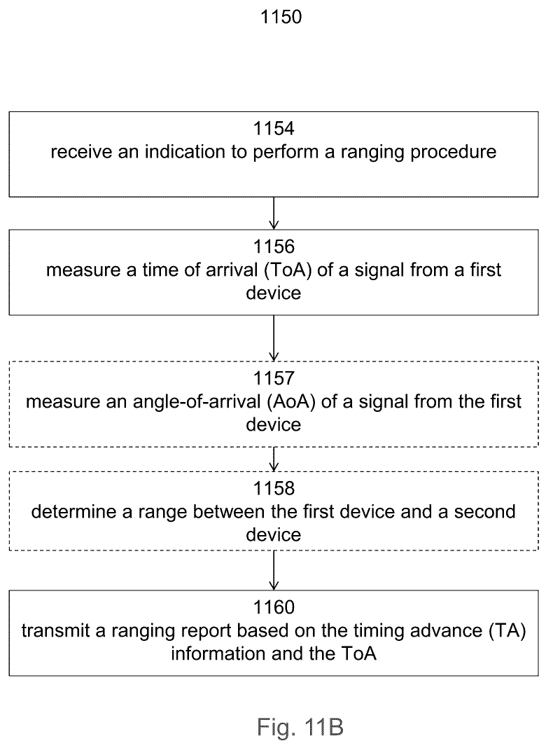

FIG. 11A is a flowchart illustrating an example method 1100 in a first wireless device, according to certain embodiments. In particular embodiments, one or more steps of FIG. 11A may be performed by wireless device 110 described with respect to FIG. 9.

The method begins at step 1112, where the first wireless device (e.g., wireless device 110) determines to perform a ranging procedure with respect to a second wireless device. In particular embodiments, determining to perform the ranging procedure is in response to receiving an indication to perform the ranging procedure from a location function (e.g., location management function (LMF), network node, wireless device, etc.). The indication to perform the ranging procedure may comprise an indication of transmission resources to use for transmitting the reference signal.

In some embodiments, the wireless device may determine to autonomously perform the ranging procedure. Some embodiments may include step 1114, where the first wireless device transmits a request to perform the ranging procedure to the location function.

Some embodiments may include step 1116, where the first wireless device requests a TA report. The wireless device may request the TA report from a base station or the location function.

At step 1118, the first wireless device transmits a reference signal using uplink TA information. The reference signal may be received and measured by the second wireless device.

In particular embodiments, the TA information comprises one TA parameter of a plurality of TA parameters configured for the first wireless device (e.g., when using one of multiple possible transmission points).

At step 1120, the wireless device receives a ranging report from the location function. The ranging report is based at least upon the TA information used for transmitting the reference signal and a measurement of the transmitted reference signal by the second wireless device.

When the first wireless device is operating in-coverage, for example, the location function may comprise an LMF or a network node. When operating out-of-coverage, the location function may comprise the second wireless device.

Modifications, additions, or omissions may be made to method 1100 of FIG. 11A. Additionally, one or more steps in the method of FIG. 11A may be performed in parallel or in any suitable order.

FIG. 11B is a flowchart illustrating an example method (1150) in second wireless device, according to certain embodiments. In particular embodiments, one or more steps of FIG. 11B may be performed by wireless device 110 described with respect to FIG. 9.

The method begins at step 1154, where the second wireless device (e.g., wireless device 110) receives an indication to perform a ranging procedure with respect to a first wireless device. In particular embodiments, the indication to perform the ranging procedure is received from a location function. In particular embodiments, the indication to perform the ranging procedure is received from the first wireless device (e.g., out-of-coverage scenario).

In particular embodiments, the indication to perform the ranging procedure comprises an indication of transmission resources to use for performing a ToA measurement on a reference signal.

At step 1156, the second wireless device measures a ToA of a reference signal received from the first wireless device. At step 1157, the second wireless device may measure an angle-of-arrival (AoA) of the reference signal received from the first wireless device.

Some embodiments may include step 1158, where the second wireless device determines a distance between the first wireless device and the second wireless device based on the TA information for the first wireless device and the ToA measurement. The transmitting the ranging report (1160) then comprises transmitting the report to the first wireless device including the determined distance, for example in out-of-coverage scenarios. In particular embodiments, the TA information comprises one TA parameter of a plurality of TA parameters configured for the second wireless device.

At step 1160, the wireless device transmits a ranging report. The ranging report is based on the TA information and the ToA. The ranging report may also be based on the measured AoA. In particular embodiments, transmitting the ranging report comprises transmitting the ranging report to the location function. In this scenario the ranging report may include one or more of the TA information, ToA, and/or AoA, and the location function may compute the distance between the first wireless device and the second wireless device, and the location function may then transmit the computed distance in a ranging report to the first wireless device.

In particular embodiments, transmitting the ranging report comprises transmitting the ranging report to the first wireless device. In this scenario the second wireless device may first compute 1158 the distance between the first wireless device and the second wireless device and the ranging report may comprise the computed distance.

Modifications, additions, or omissions may be made to method 1150 of FIG. 11B. Additionally, one or more steps in the method of FIG. 11B may be performed in parallel or in any suitable order.

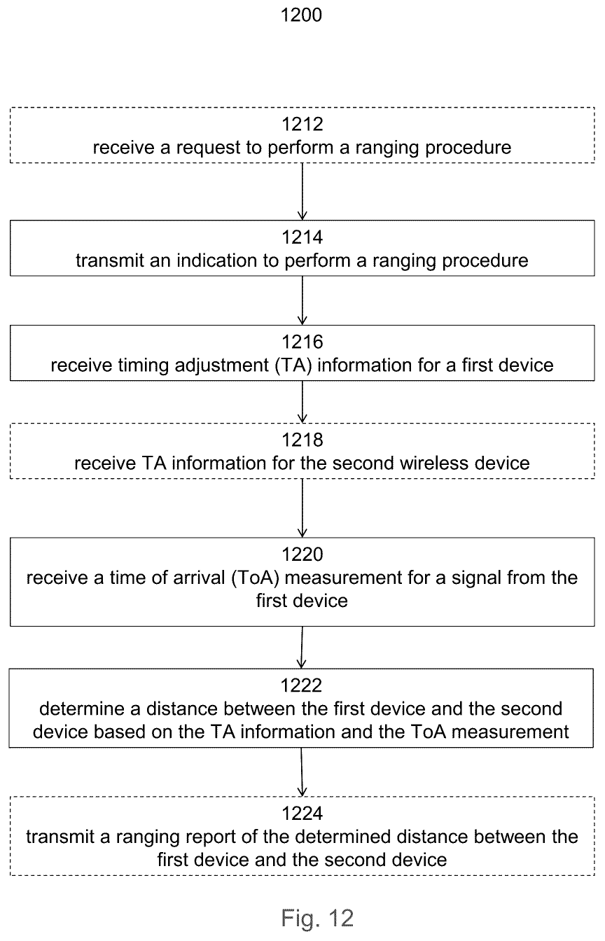

FIG. 12 is a flowchart illustrating an example method (1200) in a network node, according to certain embodiments. In particular embodiments, one or more steps of FIG. 12 may be performed by network node 160 described with respect to FIG. 9. The network node may comprise a location management function (LMF).

The method may begin at step 1212, where the network node (e.g., network node 160) receives a request to perform a ranging procedure from the first wireless device. In other embodiments, the network node initiates the ranging procedure and the method may start at step 1214, where the network node transmits an indication to perform a ranging procedure between a first wireless device and a second wireless device. The network node may transmit the indication to one or both of the first and second wireless devices. The indication to perform the ranging procedure may comprise an indication of transmission resources to use for transmitting the reference signal. In some examples the indication comprises a request to perform ToA measurements of a reference signal from the first wireless device, to be performed by a second wireless device.

At step 1216, the network node receives TA information for at least the first wireless device. The network node may receive the TA information from the first wireless device or from a network node (e.g., gNB).

At step 1218, the network node may receive TA information for the second wireless device. The network node may receive the TA information from the second wireless device or from a network node (e.g., gNB).

At step 1220, the network node receives a ToA measurement for a reference signal transmitted from the first wireless device to the second wireless device.

At step 1222, the network node determines a distance between the first wireless device and the second wireless device based on the TA information for the first wireless device and the ToA measurement. In particular embodiments, determining the distance between the first wireless device and the second wireless device is further based on the TA information for the second wireless device.

At step 1224, the network node transmits a ranging report to the first wireless device. The ranging report comprises an indication of the determined distance between the first wireless device and the second wireless device.

Modifications, additions, or omissions may be made to method 1200 of FIG. 12. Additionally, one or more steps in the method of FIG. 12 may be performed in parallel or in any suitable order.

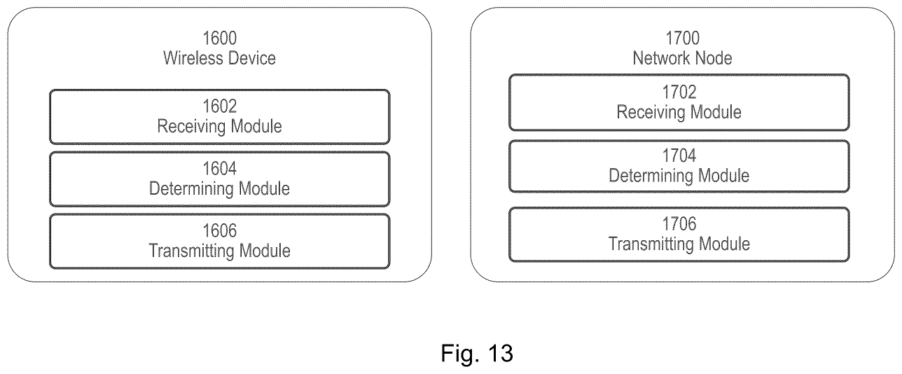

FIG. 13 illustrates a schematic block diagram of two apparatuses in a wireless network (for example, the wireless network illustrated in FIG. 9). The apparatuses may comprise a network node and a wireless device (e.g., wireless device 110 and network node 160 in FIG. 9). Apparatuses 1600 and 1700 are operable to carry out the example methods described with reference to FIGS. 11A, 11B and 12, respectively. Apparatuses 1600 and 1700 may be operable to carry out other processes or methods disclosed herein. It is also to be understood that the methods of FIGS. 11A, 11B and 12 are not necessarily carried out solely by apparatuses 1600 and 1700. At least some operations of the method can be performed by one or more other entities.

Virtual apparatus 1600 may comprise processing circuitry, which may include one or more microprocessor or microcontrollers, as well as other digital hardware, which may include digital signal processors (DSPs), special-purpose digital logic, and the like. The processing circuitry may be configured to execute program code stored in memory, which may include one or several types of memory such as read-only memory (ROM), random-access memory, cache memory, flash memory devices, optical storage devices, etc. Program code stored in memory includes program instructions for executing one or more telecommunications and/or data communications protocols as well as instructions for carrying out one or more of the techniques described herein, in several embodiments.

In some implementations, the processing circuitry may be used to cause receiving module 1602, determining module 1604, transmitting module 1606, and any other suitable units of apparatus 1600 to perform corresponding functions according one or more embodiments of the present disclosure.

As illustrated in FIG. 13, apparatus 1600 includes receiving module 1602 configured to receive ranging requests, reference signals, and ranging reports, according to any of the embodiments and examples described herein. Determining module 1604 is configured to determine measurements and compute ranges, according to any of the embodiments and examples described herein. Transmitting module 1606 is operable to transmit ranging requests, reference signals, and ranging reports, according to any of the embodiments and examples described herein.

In some implementations, the processing circuitry may be used to cause receiving module 1702, determining module 1704, transmitting module 1706, and any other suitable units of apparatus 1700 to perform corresponding functions according one or more embodiments of the present disclosure.

As illustrated in FIG. 13, apparatus 1700 includes receiving module 1702 configured to receive, from a wireless device, measurement information and TA information, according to any of the embodiments and examples described herein. Determining module 1704 is configured to compute ranges, according to any of the embodiments and examples described herein. Transmitting module 1706 is configured to transmit ranging requests and ranging reports, according to any of the embodiments and examples described herein.

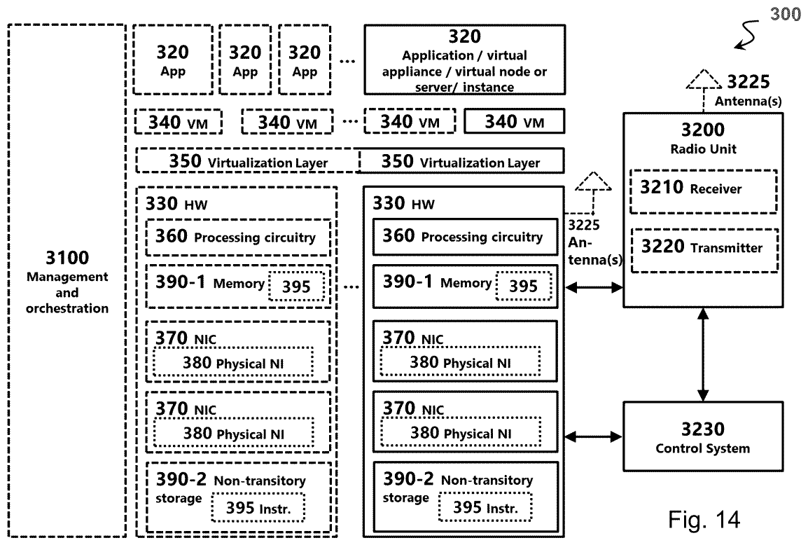

FIG. 14 is a schematic block diagram illustrating a virtualization environment 300 in which functions implemented by some embodiments may be virtualized. In the present context, virtualizing means creating virtual versions of apparatuses or devices which may include virtualizing hardware platforms, storage devices and networking resources. As used herein, virtualization can be applied to a node (e.g., a virtualized base station or a virtualized radio access node) or to a device (e.g., a UE, a wireless device or any other type of communication device) or components thereof and relates to an implementation in which at least a portion of the functionality is implemented as one or more virtual components (e.g., via one or more applications, components, functions, virtual machines or containers executing on one or more physical processing nodes in one or more networks).

In some embodiments, some or all of the functions described herein may be implemented as virtual components executed by one or more virtual machines implemented in one or more virtual environments 300 hosted by one or more of hardware nodes 330. Further, in embodiments in which the virtual node is not a radio access node or does not require radio connectivity (e.g., a core network node), then the network node may be entirely virtualized.

The functions may be implemented by one or more applications 320 (which may alternatively be called software instances, virtual appliances, network functions, virtual nodes, virtual network functions, etc.) operative to implement some of the features, functions, and/or benefits of some of the embodiments disclosed herein. Applications 320 are run in virtualization environment 300 which provides hardware 330 comprising processing circuitry 360 and memory 390. Memory 390 contains instructions 395 executable by processing circuitry 360 whereby application 320 is operative to provide one or more of the features, benefits, and/or functions disclosed herein.

Virtualization environment 300, comprises general-purpose or special-purpose network hardware devices 330 comprising a set of one or more processors or processing circuitry 360, which may be commercial off-the-shelf (COTS) processors, dedicated Application Specific Integrated Circuits (ASICs), or any other type of processing circuitry including digital or analog hardware components or special purpose processors. Each hardware device may comprise memory 390-1 which may be non-persistent memory for temporarily storing instructions 395 or software executed by processing circuitry 360. Each hardware device may comprise one or more network interface controllers (NICs) 370, also known as network interface cards, which include physical network interface 380. Each hardware device may also include non-transitory, persistent, machine-readable storage media 390-2 having stored therein software 395 and/or instructions executable by processing circuitry 360. Software 395 may include any type of software including software for instantiating one or more virtualization layers 350 (also referred to as hypervisors), software to execute virtual machines 340 as well as software allowing it to execute functions, features and/or benefits described in relation with some embodiments described herein.

Virtual machines 340, comprise virtual processing, virtual memory, virtual networking or interface and virtual storage, and may be run by a corresponding virtualization layer 350 or hypervisor. Different embodiments of the instance of virtual appliance 320 may be implemented on one or more of virtual machines 340, and the implementations may be made in different ways.

During operation, processing circuitry 360 executes software 395 to instantiate the hypervisor or virtualization layer 350, which may sometimes be referred to as a virtual machine monitor (VMM). Virtualization layer 350 may present a virtual operating platform that appears like networking hardware to virtual machine 340.

As shown in FIG. 14, hardware 330 may be a standalone network node with generic or specific components. Hardware 330 may comprise antenna 3225 and may implement some functions via virtualization. Alternatively, hardware 330 may be part of a larger cluster of hardware (e.g. such as in a data center or customer premise equipment (CPE)) where many hardware nodes work together and are managed via management and orchestration (MANO) 3100, which, among others, oversees lifecycle management of applications 320.

Virtualization of the hardware is in some contexts referred to as network function virtualization (NFV). NFV may be used to consolidate many network equipment types onto industry standard high-volume server hardware, physical switches, and physical storage, which can be located in data centers, and customer premise equipment.

In the context of NFV, virtual machine 340 may be a software implementation of a physical machine that runs programs as if they were executing on a physical, non-virtualized machine. Each of virtual machines 340, and that part of hardware 330 that executes that virtual machine, be it hardware dedicated to that virtual machine and/or hardware shared by that virtual machine with others of the virtual machines 340, forms a separate virtual network elements (VNE).

Still in the context of NFV, Virtual Network Function (VNF) is responsible for handling specific network functions that run in one or more virtual machines 340 on top of hardware networking infrastructure 330 and corresponds to application 320 in FIG. 14.

In some embodiments, one or more radio units 3200 that each include one or more transmitters 3220 and one or more receivers 3210 may be coupled to one or more antennas 3225. Radio units 3200 may communicate directly with hardware nodes 330 via one or more appropriate network interfaces and may be used in combination with the virtual components to provide a virtual node with radio capabilities, such as a radio access node or a base station.

In some embodiments, some signaling can be effected with the use of control system 3230 which may alternatively be used for communication between the hardware nodes 330 and radio units 3200.

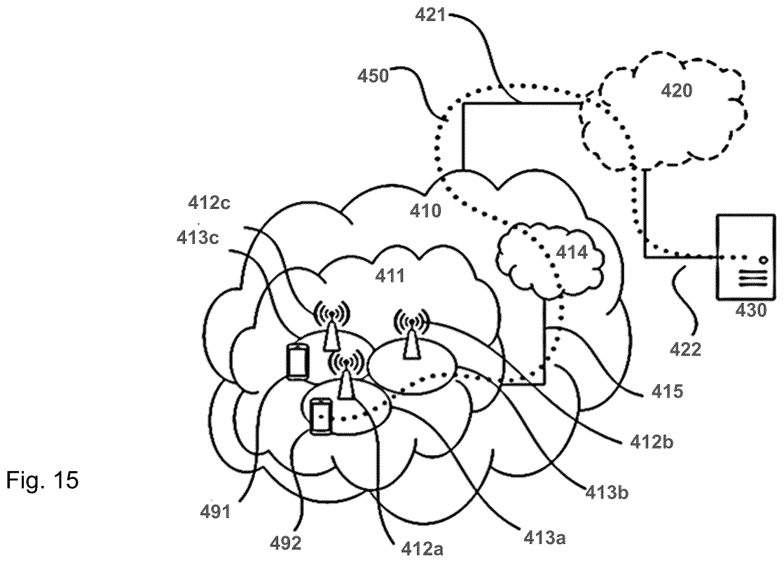

With reference to FIG. 15, in accordance with an embodiment, a communication system includes telecommunication network 410, such as a 3GPP-type cellular network, which comprises access network 411, such as a radio access network, and core network 414. Access network 411 comprises a plurality of base stations 412a, 412b, 412c, such as NBs, eNBs, gNBs or other types of wireless access points, each defining a corresponding coverage area 413a, 413b, 413c. Each base station 412a, 412b, 412c is connectable to core network 414 over a wired or wireless connection 415. A first UE 491 located in coverage area 413c is configured to wirelessly connect to, or be paged by, the corresponding base station 412c. A second UE 492 in coverage area 413a is wirelessly connectable to the corresponding base station 412a. While a plurality of UEs 491, 492 are illustrated in this example, the disclosed embodiments are equally applicable to a situation where a sole UE is in the coverage area or where a sole UE is connecting to the corresponding base station 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider or may be operated by the service provider or on behalf of the service provider. Connections 421 and 422 between telecommunication network 410 and host computer 430) may extend directly from core network 414 to host computer 430 or may go via an optional intermediate network 420. Intermediate network 420 may be one of, or a combination of more than one of, a public, private or hosted network: intermediate network 420, if any, may be a backbone network or the Internet: in particular, intermediate network 420 may comprise two or more sub-networks (not shown).

The communication system of FIG. 15 as a whole enables connectivity between the connected UEs 491, 492 and host computer 430. The connectivity may be described as an over-the-top (OTT) connection 450. Host computer 430) and the connected UEs 491, 492 are configured to communicate data and/or signaling via OTT connection 450, using access network 411, core network 414, any intermediate network 420 and possible further infrastructure (not shown) as intermediaries. OTT connection 450) may be transparent in the sense that the participating communication devices through which OTT connection 450 passes are unaware of routing of uplink and downlink communications. For example, base station 412 may not or need not be informed about the past routing of an incoming downlink communication with data originating from host computer 430 to be forwarded (e.g., handed over) to a connected UE 491. Similarly, base station 412 need not be aware of the future routing of an outgoing uplink communication originating from the UE 491 towards the host computer 430).

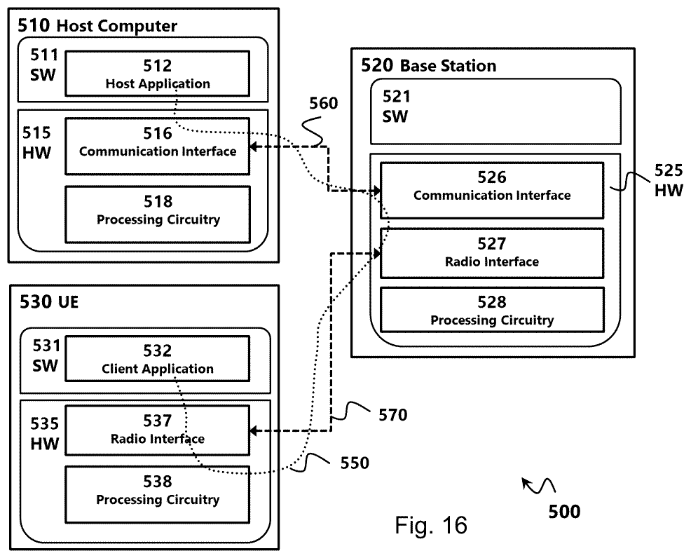

FIG. 16 illustrates an example host computer communicating via a base station with a user equipment over a partially wireless connection, according to certain embodiments. Example implementations, in accordance with an embodiment of the UE, base station and host computer discussed in the preceding paragraphs will now be described with reference to FIG. 16. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes base station 520 provided in a telecommunication system and comprising hardware 525 enabling it to communicate with host computer 510 and with UE 530. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 16) served by base station 520. Communication interface 526 may be configured to facilitate connection 560 to host computer 510. Connection 560 may be direct, or it may pass through a core network (not shown in FIG. 16) of the telecommunication system and/or through one or more intermediate networks outside the telecommunication system. In the embodiment shown, hardware 525 of base station 520 further includes processing circuitry 528, which may comprise one or more programmable processors, application-specific integrated circuits, field programmable gate arrays or combinations of these (not shown) adapted to execute instructions. Base station 520 further has software 521 stored internally or accessible via an external connection.

Communication system 500 further includes UE 530 already referred to. Its hardware 535 may include radio interface 537 configured to set up and maintain wireless connection 570) with a base station serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, base station 520 and UE 530 illustrated in FIG. 16 may be similar or identical to host computer 430, one of base stations 412a, 412b, 412c and one of UEs 491, 492 of FIG. 15, respectively. This is to say, the inner workings of these entities may be as shown in FIG. 16 and independently, the surrounding network topology may be that of FIG. 15.

In FIG. 16, OTT connection 550 has been drawn abstractly to illustrate the communication between host computer 510 and UE 530 via base station 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., based on load balancing consideration or reconfiguration of the network).

Wireless connection 570 between UE 530 and base station 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may improve the signaling overhead and reduce latency, which may provide faster internet access for users.

A measurement procedure may be provided for monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes: the sensors may participate in the measurement procedure by supplying values of the monitored quantities exemplified above or supplying values of other physical quantities from which software 511, 531 may compute or estimate the monitored quantities. The reconfiguring of OTT connection 550 may include message format, retransmission settings, preferred routing etc.: the reconfiguring need not affect base station 520, and it may be unknown or imperceptible to base station 520. Such procedures and functionalities may be known and practiced in the art. In certain embodiments, measurements may involve proprietary UE signaling facilitating host computer 510's measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

FIG. 17 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 17 will be included in this section.

In step 610, the host computer provides user data. In substep 611 (which may be optional) of step 610, the host computer provides the user data by executing a host application. In step 620, the host computer initiates a transmission carrying the user data to the UE. In step 630 (which may be optional), the base station transmits to the UE the user data which was carried in the transmission that the host computer initiated, in accordance with the teachings of the embodiments described throughout this disclosure. In step 640 (which may also be optional), the UE executes a client application associated with the host application executed by the host computer.

FIG. 18 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 18 will be included in this section.

In step 710 of the method, the host computer provides user data. In an optional substep (not shown) the host computer provides the user data by executing a host application. In step 720, the host computer initiates a transmission carrying the user data to the UE. The transmission may pass via the base station, in accordance with the teachings of the embodiments described throughout this disclosure. In step 730 (which may be optional), the UE receives the user data carried in the transmission.

FIG. 19 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 19 will be included in this section.

In step 810 (which may be optional), the UE receives input data provided by the host computer. Additionally, or alternatively, in step 820, the UE provides user data. In substep 821 (which may be optional) of step 820, the UE provides the user data by executing a client application. In substep 811 (which may be optional) of step 810, the UE executes a client application which provides the user data in reaction to the received input data provided by the host computer. In providing the user data, the executed client application may further consider user input received from the user. Regardless of the specific manner in which the user data was provided, the UE initiates, in substep 830 (which may be optional), transmission of the user data to the host computer. In step 840 of the method, the host computer receives the user data transmitted from the UE, in accordance with the teachings of the embodiments described throughout this disclosure.

FIG. 20 is a flowchart illustrating a method implemented in a communication system, in accordance with one embodiment. The communication system includes a host computer, a base station and a UE which may be those described with reference to FIGS. 15 and 16. For simplicity of the present disclosure, only drawing references to FIG. 20 will be included in this section.

In step 910 (which may be optional), in accordance with the teachings of the embodiments described throughout this disclosure, the base station receives user data from the UE. In step 920 (which may be optional), the base station initiates transmission of the received user data to the host computer. In step 930 (which may be optional), the host computer receives the user data carried in the transmission initiated by the base station.

The term unit may have conventional meaning in the field of electronics, electrical devices and/or electronic devices and may include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Modifications, additions, or omissions may be made to the systems and apparatuses disclosed herein without departing from the scope of the invention. The components of the systems and apparatuses may be integrated or separated. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the invention. The methods may include more, fewer, or other steps. Additionally, steps may be performed in any suitable order.

The foregoing description sets forth numerous specific details. It is understood, however, that embodiments may be practiced without these specific details. In other instances, well-known circuits, structures and techniques have not been shown in detail in order not to obscure the understanding of this description. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to implement such feature, structure, or characteristic in connection with other embodiments, whether or not explicitly described.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the scope of this disclosure, as defined by the claims below.

Some example embodiments are included below.

1. An example method performed by a wireless device, the method comprising:
receiving from a location function an indication to perform a ranging procedure;
transmitting a reference signal to one or more wireless devices using an uplink timing advance (TA) parameter; and
reporting the TA parameter to the location function.

2. The method of example 1, wherein the indication to perform the ranging procedure comprises an indication of transmission resources to use for transmitting the reference signal.

3. The method of any one of examples 1-2, wherein the location function comprises at least one of a Location Management Function (LMF), base station, and wireless device.

4. The method of any one of examples 1-3, wherein the TA parameter is one TA parameter of a plurality of TA parameters configured for the wireless device.

5. The method of any one of examples 1-4, further comprising transmitting a request to perform the ranging procedure to the location function.

6. The method of any one of examples 1-5, further comprising determining a distance between the wireless device and the one or more wireless devices based on the TA parameter and a TA parameter from the one or more wireless devices and a ToA value from the one or more wireless devices.

7. An example method performed by a wireless device, the method comprising:
receiving from a location function an indication to perform a ranging procedure;
measuring a time of arrival (ToA) of reference signal from another wireless device using an uplink timing advance (TA) parameter; and
reporting the TA parameter and the ToA to the location function.

8. The method of example 7, wherein the indication to perform a ranging procedure comprises an indication of transmission resources to use for measuring the reference signal.

9. The method of any one of examples 7-8, wherein the location function comprises at least one of a Location Management Function (LMF), base station, and wireless device.

10. The method of any one of examples 7-9, wherein the TA parameter is one TA parameter of a plurality of TA parameters configured for the wireless device.

11. An example method performed by a wireless device, the method comprising:
any of the wireless device steps, features, or functions described above, either alone or in combination with other steps, features, or functions described above.

12. The method of the previous example, further comprising one or more additional wireless device steps, features or functions described above.

13. The method of any of the previous examples, further comprising:
providing user data; and
forwarding the user data to a host computer via the transmission to the base station.

14. An example method performed by a location function, the method comprising:
transmitting an indication to perform a ranging procedure between a first wireless device and a second wireless device to the first wireless device;
transmitting an indication to perform the ranging procedure between the first wireless device and the second wireless device to the second wireless device;
receiving a timing adjustment (TA) parameter from the first wireless device;
receiving a TA parameter and a time of arrival (ToA) value for a reference signal transmitted from the first wireless device to the second wireless device from the second wireless device; and
determining a distance between the first wireless device and the second wireless device based on the TA parameter from the first wireless device and the TA parameter and the ToA value from the second wireless device.

15. The method of example 14, wherein the indication to perform the ranging procedure comprises an indication of transmission resources to use for transmitting the reference signal.

16. The method of any one of examples 14-15, wherein the location function comprises at least one of a Location Management Function (LMF), base station, and wireless device.

17. The method of any one of examples 14-16, wherein the TA parameter from the first wireless device is one TA parameter of a plurality of TA parameters configured for the first wireless device.

18. The method of any one of examples 14-17, wherein the TA parameter from the second wireless device is one TA parameter of a plurality of TA parameters configured for the second wireless device.

19. The method of any one of examples 14-18, further comprising receiving a request to perform the ranging procedure from the first wireless device.

20. An example method performed by a base station, the method comprising:
any of the steps, features, or functions described above with respect to base station, either alone or in combination with other steps, features, or functions described above.

21. The method of any of the previous examples, further comprising:
obtaining user data; and
forwarding the user data to a host computer or a wireless device.

22. An example mobile terminal comprising:
processing circuitry configured to perform any of the steps of any of the Group A embodiments; and
power supply circuitry configured to supply power to the wireless device.

23. An example base station comprising:
processing circuitry configured to perform any of the steps of any of the Group B embodiments;
power supply circuitry configured to supply power to the wireless device.

24. An example user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

25. An example communication system including a host computer comprising:
processing circuitry configured to provide user data; and
a communication interface configured to forward the user data to a cellular network for transmission to a user equipment (UE),
wherein the cellular network comprises a base station having a radio interface and processing circuitry, the base station's processing circuitry configured to perform any of the steps of any of the Group B embodiments.

26. The communication system of the pervious example further including the base station.

27. The communication system of the previous 2 examples, further including the UE, wherein the UE is configured to communicate with the base station.

28. The communication system of the previous 3 examples, wherein:
the processing circuitry of the host computer is configured to execute a host application, thereby providing the user data; and
the UE comprises processing circuitry configured to execute a client application associated with the host application.

29. An example method implemented in a communication system including a host computer, a base station and a user equipment (UE), the method comprising:
at the host computer, providing user data; and
at the host computer, initiating a transmission carrying the user data to the UE via a cellular network comprising the base station, wherein the base station performs any of the steps of any of the Group B embodiments.

30. The method of the previous example, further comprising, at the base station, transmitting the user data.

31. The method of the previous 2 examples, wherein the user data is provided at the host computer by executing a host application, the method further comprising, at the UE, executing a client application associated with the host application.

32. An example user equipment (UE) configured to communicate with a base station, the UE comprising a radio interface and processing circuitry configured to performs any of the previous 3 embodiments.

33. An example communication system including a host computer comprising:
processing circuitry configured to provide user data; and
a communication interface configured to forward user data to a cellular network for transmission to a user equipment (UE),
wherein the UE comprises a radio interface and processing circuitry, the UE's components configured to perform any of the steps of any of the Group A embodiments.

34. The communication system of the previous example, wherein the cellular network further includes a base station configured to communicate with the UE.

35. The communication system of the previous 2 examples, wherein:
the processing circuitry of the host computer is configured to execute a host application, thereby providing the user data; and
the UE's processing circuitry is configured to execute a client application associated with the host application.

36. An example method implemented in a communication system including a host computer, a base station and a user equipment (UE), the method comprising:
at the host computer, providing user data; and
at the host computer, initiating a transmission carrying the user data to the UE via a cellular network comprising the base station, wherein the UE performs any of the steps of any of the Group A embodiments.

37. The method of the previous example, further comprising at the UE, receiving the user data from the base station.

38. An example communication system including a host computer comprising:
communication interface configured to receive user data originating from a transmission from a user equipment (UE) to a base station,
wherein the UE comprises a radio interface and processing circuitry, the UE's processing circuitry configured to perform any of the steps of any of the Group A embodiments.

39. The communication system of the previous example, further including the UE.

40. The communication system of the previous 2 examples, further including the base station, wherein the base station comprises a radio interface configured to communicate with the UE and a communication interface configured to forward to the host computer the user data carried by a transmission from the UE to the base station.

41. The communication system of the previous 3 examples, wherein:
the processing circuitry of the host computer is configured to execute a host application; and
the UE's processing circuitry is configured to execute a client application associated with the host application, thereby providing the user data.

42. The communication system of the previous 4 examples, wherein:
the processing circuitry of the host computer is configured to execute a host application, thereby providing request data; and
the UE's processing circuitry is configured to execute a client application associated with the host application, thereby providing the user data in response to the request data.

43. An example method implemented in a communication system including a host computer, a base station and a user equipment (UE), the method comprising:
at the host computer, receiving user data transmitted to the base station from the UE, wherein the UE performs any of the steps of any of the Group A embodiments.

44. The method of the previous example, further comprising, at the UE, providing the user data to the base station.

45. The method of the previous 2 examples, further comprising:
at the UE, executing a client application, thereby providing the user data to be transmitted; and
at the host computer, executing a host application associated with the client application.

46. The method of the previous 3 examples, further comprising:
at the UE, executing a client application; and
at the UE, receiving input data to the client application, the input data being provided at the host computer by executing a host application associated with the client application,
wherein the user data to be transmitted is provided by the client application in response to the input data.

47. An example communication system including a host computer comprising a communication interface configured to receive user data originating from a transmission from a user equipment (UE) to a base station, wherein the base station comprises a radio interface and processing circuitry, the base station's processing circuitry configured to perform any of the steps of any of the Group B embodiments.

48. The communication system of the previous example further including the base station.

49. The communication system of the previous 2 examples, further including the UE, wherein the UE is configured to communicate with the base station.

50. The communication system of the previous 3 examples, wherein:
the processing circuitry of the host computer is configured to execute a host application;
the UE is configured to execute a client application associated with the host application, thereby providing the user data to be received by the host computer.

51. An example method implemented in a communication system including a host computer, a base station and a user equipment (UE), the method comprising:
at the host computer, receiving, from the base station, user data originating from a transmission which the base station has received from the UE, wherein the UE performs any of the steps of any of the Group A embodiments.

52. The method of the previous example, further comprising at the base station, receiving the user data from the UE.

53. The method of the previous 2 examples, further comprising at the base station, initiating a transmission of the received user data to the host computer.

1. A method performed by a first wireless device, the method comprising:
determining to perform a ranging procedure with respect to a second wireless device;
transmitting a reference signal using uplink timing advance, TA, information; and
receiving a ranging report from a location function, the ranging report based at least upon the TA information used for transmitting the reference signal and a measurement of the transmitted reference signal by the second wireless device.

2. The method of claim 1, further comprising transmitting a request to perform the ranging procedure to the location function.

3. The method of claim 1, wherein determining to perform the ranging procedure is in response to receiving an indication to perform the ranging procedure from the location function.

4.-5. (canceled)

6. The method of claim 1, further comprising requesting a TA report from the location function.

7. The method of claim 1, wherein the location function comprises at least one of a Location Management Function, LMF, base station, and wireless device.

8. A first wireless device comprising processing circuitry operable to:
determine to perform a ranging procedure with respect to a second wireless device;
transmit a reference signal using uplink timing advance, TA, information; and
receive a ranging report from the location function, the ranging report based at least upon the TA information used for transmitting the reference signal and a measurement of the transmitted reference signal by the second wireless device.

9. The wireless device of claim 8, wherein the processing circuitry is further operable to transmit a request to perform the ranging procedure to the location function.

10. A method performed by a second wireless device, the method comprising:
receiving an indication to perform a ranging procedure with respect to a first wireless device;
measuring a time of arrival, ToA, of a reference signal received from the first wireless device; and
transmitting a ranging report, the ranging report based on the timing advance, TA, information and the ToA measurement.

11. The method of claim 10, wherein the indication to perform the ranging procedure is received from a location function and transmitting the ranging report comprises transmitting the ToA measurement and TA information to the location function.

12. The method of claim 10, wherein the indication to perform the ranging procedure is received from the first wireless device and transmitting the ranging report comprises:
determining a distance between the first wireless device and the second wireless device based on the TA information for the first wireless device and the ToA measurement and transmitting the ranging report to the first wireless device.

13.-14. (canceled)

15. The method of claim 10, further comprising measuring an angle-of-arrival, AoA, of the reference signal received from the first wireless device; and wherein the ranging report is further based on the AoA.

16. The method of claim 10, wherein the location function comprises at least one of a Location Management Function, LMF, and a base station.

17. A second wireless device comprising processing circuitry operable to:
receive an indication to perform a ranging procedure with respect to a first wireless device;
measure a time of arrival, ToA, of a reference signal received from the first wireless device; and
transmit a ranging report, the ranging report based on the timing advance, TA, information and the ToA measurement.

18. The wireless device of claim 17, wherein the indication to perform the ranging procedure is received from a location function and processing circuitry operable to transmit the ranging report comprises processing circuitry operable to transmit the ToA measurement and TA information to the location function.

19. (canceled)

20. The method of claim 17, further comprising transmitting a ranging report to the first wireless device, the ranging report comprising an indication of the determined distance between the first wireless device and the second wireless device.

21. The method of claim 17, further comprising receiving a request to perform the ranging procedure from the first wireless device.

22. The method of claim 17, wherein the indication to perform the ranging procedure comprises a request to perform the ToA measurement and is transmitted to the second wireless device.

23. The method of claim 17, wherein the indication to perform the ranging procedure comprises an indication of transmission resources to use for transmitting the reference signal and/or performing the ToA measurement.

24. The method of claim 17, further comprising receiving TA information for the second wireless device and determining the distance between the first wireless device and the second wireless device is further based on the TA information for the second wireless device.

25. (canceled)

26. The method of claim 17, wherein receiving the TA information comprises receiving a TA report from a base station.

27. The method of claim 17, wherein network node comprises a Location Management Function, LMF.

28. A network node capable processing circuitry operable to:
transmit an indication to perform a ranging procedure between a first wireless device and a second wireless device to the first wireless device;
transmit an indication to perform the ranging procedure between the first wireless device and the second wireless device to the second wireless device;
receive timing advance, TA, information for the first wireless device;
receive TA information for the second wireless device and a time of arrival, ToA, value for a reference signal transmitted from the first wireless device to the second wireless device; and
determine a distance between the first wireless device and the second wireless device based on the TA information from the first wireless device and the TA information and the ToA value from the second wireless device.

29. The network node of claim 28, wherein the processing circuitry is further operable to transmit a ranging report to the first wireless device, the ranging report comprising an indication of the determined distance between the first wireless device and the second wireless device.
